(19) United States
(12) Patent Application Publication
(10) Pub. No.: US 2012/0224042 A1
(43) Pub. Date: Sep. 6, 2012

(54) INFORMATION PROCESSING APPARATUS, INFORMATION PROCESSING METHOD, PROGRAM, AND ELECTRONIC APPARATUS

(75) Inventor: Nobuhiro Saijo, Tokyo (JP)

(73) Assignee: Sony Corporation, Tokyo (JP)

(21) Appl. No.: 13/509,385

(22) PCT Filed: Nov. 10, 2010
(86) PCT No.: PCT/JP2010/070025

§ 371 Date: May 11, 2012

(30) Foreign Application Priority Data
Nov. 18, 2009 (JP) 2009-262511
Nov. 2, 2010 (JP) 2010-246902

(51) Int. Cl. H04N 7/18

(52) U.S. Cl. 348/77; 348/E07.085

(57) ABSTRACT

The present invention relates to an information processing apparatus, an information processing method, a program, and an electronic apparatus which can detect a skin region with high degree of accuracy even when a rolling-shutter-type camera is employed. LEDs 61a emit light having a first wavelength, LEDs 61b emit light having a second wavelength, a camera 62 receives reflected light from an object at different timings for each of a plurality of lines which constitute an image pickup element integrated therein and creates first and second picked-up images which include at least a skin detection region used for detecting the skin region. A control unit 101 controls the LED 61a, the LEDs 61b, and the camera 62, and a binary unit 104 detects the skin region on the basis of the first picked-up image created when irradiated with the light having the first wavelength and the second picked-up image created when irradiated with the light having the second wavelength. The present invention may be applied to, for example, the information processing apparatus configured to detect the skin region from the picked-up image obtained by imaging the object.

### TECHNICAL FIELD

The present invention relates to an information processing apparatus, an information processing method, a program, and an electronic apparatus and, more specifically, to an information processing apparatus, an information processing method, a program, and an electronic apparatus preferably used when detecting the shape of a human hand or the like from a picked-up image obtained by imaging an object.

### BACKGROUND ART

In the related art, a skin recognizing system which detects (recognizes) a skin region indicating human skin from a picked-up image obtained by imaging an object exists (see Non-Patent Document 1, for example).

### [An Example of Skin Recognizing System of the Related Art]

FIG. 1 is an example of a configuration of a skin recognizing system 1 of the related art.

The skin recognizing system 1 includes a light-emitting device 21, a camera 22, and an image processing apparatus 23.

The light-emitting device 21 includes an LED (light emitting diode) 21a₁ and an LED 21a₂ (shown by two solid circles, respectively) configured to irradiate (emit) light beam having a wavelength λ1 (for example, a near infrared ray of 870 [nm], and an LED 21b₁ and an LED 21b₂ (shown by two hollow circles, respectively) configured to irradiate light beam having a wavelength λ2 different from the wavelength λ1 (for example, a near infrared ray of 950 [nm]).

In the following description, when there is no necessity of discriminating the LED 21a₁ and the LED 21a₂, the LED 21a₁ and the LED 21a₂ are expressed simply as LEDs 21a. Also, when there is no necessity of discriminating the LED 21b₁ and the LED 21b₂, the LED 21b₁ and the LED 21b₂ are expressed simply as LEDs 21b.

In addition, a combination of the wavelengths λ1 and λ2 is a combination in which the reflectance when human skin is irradiated with the light beam having the wavelength λ1 is larger than the reflectance when the human skin is irradiated with the light beam having the wavelength λ2, for example. Also, a combination of the wavelengths λ1 and λ2 is a combination in which the reflectance when substances other than the human skin are irradiated with the light beam having the wavelength λ1 is almost the same as the reflectance when the substances other than the human skin are irradiated with the light beam having the wavelength λ2.

Then, the outputs from the LEDs 21a and the LEDs 21b are adjusted respectively so that the luminance values of corresponding pixels of a picked-up image obtained by imaging using the camera 22 becomes the same irrespective of which one of light beams having the wavelengths λ1 and λ2 is emitted to an object having the same reflectance with respect to the wavelengths λ1 and λ2.

The LEDs 21a and the LEDs 21b are arranged in a matrix manner respectively and emit light beams, for example, alternately.

The camera 22 has a lens used for imaging of the object such as a user, and a front surface of the lens is covered with a visible light cut filter 22a which cuts visible light.

Therefore, except for sunlight or invisible light components such as fluorescent light or he like, the camera 22 receives only a reflected light of the invisible light with which the object is irradiated by the light-emitting device 21, and the picked-up image obtained thereby is supplied to the image processing apparatus 23.

Employed as the camera 22 is a global-shutter-type camera provided with an image pickup element configured to receive the reflected light from the object integrated therein and configured to perform exposure which receives the reflected light from the object at the same timing for a plurality of horizontal lines which constitute the integrated image pickup element.

The camera 22 images the object, and supplies the picked-up image obtained thereby to the image processing apparatus 23.

[An Example of a Case where a Global-Shutter-Type Camera is Employed]

Subsequently, referring to FIG. 2 and FIG. 3, the global-shutter-type camera employed as the camera 22 will be described.

FIG. 2 shows an example of an image pickup element 22b integrated in the camera 22.

The image pickup element 22b includes a plurality of light-receiving elements and, as shown in FIG. 2, the plurality of light-emitting elements form the plurality of horizontal lines 0 to 11.

Subsequently, FIG. 3 shows an operation of the global-shutter type camera employed as the camera 22.

In FIG. 3, an HD signal (horizontal synchronous signal) and a VD signal (vertical synchronous signal) are signals generated by the image processing apparatus 23, and shows signals used for controlling the light-emitting device 21 and the camera 22.

In FIG. 3, irradiating times t1, t3, . . . show times during which the object is irradiated with the light beams having the wavelength λ1 by the LEDs 21a. Also, irradiating times t2, t4, . . . show times during which the object is irradiated with the light beams having the wavelength λ2 by the LEDs 21b. In FIG. 3, the irradiating times t1, t2, t3, t4, . . . are determined by intervals of rising edges appeared in the VD signal.

In addition, the numerals 0 to 11 shown on the left side in FIG. 3 indicate twelve horizontal lines 0 to 11 which constitute the image pickup element 22b integrated in the global-shutter-type camera, respectively.

In right-angled triangles shown in FIG. 3 (shown by hatching), the lateral length designates the exposure time during which the exposure is performed, and the vertical length (height) designates an amount of charge accumulated according to the exposure time.

For example, the LEDs 21a irradiate the object with the light beam having the wavelength λ1 for the irradiating time t1. Also, the camera 22 performs the exposure of the horizontal lines 0 to 11, respectively which constitute the image pickup element 22b integrated therein for the irradiating time t1 at the same timing when the irradiating time t1 is started.

In this case, as shown in FIG. 3, the amount of charge obtained by the exposure for the respective horizontal lines 0 to 11 which constitute the image pickup element 22b is obtained by receiving only the reflected light reflected when the object is irradiated with the light beam having the wavelength λ1. Therefore, the camera 22 creates a first picked-up image on the basis of the amount of charge obtained by receiving only the reflected light reflected when the object is irradiated with the light beam having the wavelength λ1, and supplies the same to the image processing apparatus 23. Also, for example, the LEDs 21b irradiate the object with the light beam having the wavelength λ2 as long as the irradiating time t2. In addition, the camera 22 performs the exposure of the horizontal lines 0 to 11, respectively which constitute the image pickup element 22b integrated therein as long as the irradiating time t2 at the same timing when the irradiating time t2 is started.

In this case, as shown in FIG. 3, the amount of charge obtained by the exposure for the respective horizontal lines 0 to 11 which constitute the image pickup element 22b is obtained by receiving only the reflected light reflected when the object is irradiated with the light beam having the wavelength λ2. Therefore, the camera 22 creates a second picked-up image on the basis of the amount of charge obtained by receiving only the reflected light reflected when the object is irradiated with the light beam having the wavelength λ2, and supplies the same to the image processing apparatus 23.

The image processing apparatus 23 generates the VD signal and the HD signal. Then, the image processing apparatus 23 controls light emission of the light-emitting device 21 and imaging of the camera 22 on the basis of, for example, intervals of rising edges appearing in the generated VD signal and HD signal.

The image processing apparatus 23 calculates differential absolute values between the luminance values of the corresponding pixels of the first and second picked-up images from the camera 22 and, on the basis of the calculated differential absolute values, detects skin regions on the first picked-up image (or the second picked-up image).

In other words, the first picked-up image is obtained by receiving only the reflected light reflected when the object is irradiated with the light beam having the wavelength λ1, and the second picked-up image is obtained by receiving only the reflected light reflected when the object is irradiated with the light beam having the wavelength λ2.

Also, employed as a combination of the wavelengths λ1 and λ2 is a combination in which the reflectance when the human skin is irradiated with the light beam having the wavelength λ1 is larger than the reflectance when the human skin is irradiated with the light beam having the wavelength λ2.

Therefore, the luminance values of the pixels which constitute the skin region on the first picked-up image are relatively large values, and the luminance values of the pixels which constitute the skin region on the second picked-up image are relatively small values. Therefore, the differential absolute values of the luminance values of the pixels which constitute the skin regions on the first and second picked-up images are relatively large values.

Furthermore, employed as a combination of the wavelengths λ1 and λ2 is a combination in which the reflectance when the substances other than the human skin are irradiated with the light beam having the wavelength λ1 is almost the same as the reflectance when the substances other than the human skin are irradiated with the light beam having the wavelength λ2.

Therefore, the luminance values of the pixels which constitute regions other than the skin region on the first picked-up image and the luminance values of the pixels which constitute regions other than the skin region on the second picked-up image are almost the same value. Therefore, the differential absolute values of the luminance values of the pixels which constitute the regions other than the skin regions on the first and second picked-up images are relatively small values.

Therefore, for example, when the differential value is a relatively large value, the image processing apparatus 23 can detect the corresponding regions as the skin regions.

### CITED REFERENCE

### Patent Document

Non-Patent Document 1: Literature of the Institute of Electrical Engineers of Japan C (Detection Method of Skin Region by Near IR Spectrum Multi-Band) by Yasuhiro Suzuki, Volume 127-4, 2007, Japan.

### SUMMARY OF INVENTION

### Problems to be Solved by the Invention

Incidentally, the global-shutter-type camera such as the camera 22 is high in production cost in comparison with a rolling-shutter-type camera which performs exposure at different timings by the plurality of horizontal lines 0 to 11 which constitute the image pickup element 22b.

Therefore, when the global-shutter-type camera 22 is employed as in the skin recognizing system 1 of the related art, the production cost of the skin recognizing system 1 by itself is also increased.

Accordingly, it is preferable to employ the rolling-shutter-type camera which is available with cost as low as a cost on the order of 1/10 of the global-shutter-type camera in the skin recognizing system 1.

However, in the skin recognizing system 1 of the related art, when the rolling-shutter type camera is employed as the camera 22, it becomes difficult to detect the skin region using the difference in reflection ratio between the wavelength λ1 and the wavelength λ2, and hence the accuracy to detect the skin region is significantly lowered.

In view of such circumstances, the present invention enables to detect a skin region with high degree of accuracy on the basis of first and second picked-up images imaged by a camera by adjusting an exposure time of the camera and an irradiating time of a light-emitting device on the premise of employment of a rolling-shutter-type camera.

### Means for Solving the Problems

An information processing apparatus according to a first aspect of the present invention is an information processing apparatus configured to detect a skin region which indicates human skin from a picked-up image obtained by imaging an object including: first irradiating means configured to irradiate the object with light having a first wavelength; second irradiating means configured to irradiate the object with light having a second wavelength which is longer than the first wavelength; creating means including an image pickup element having a plurality of lines including skin detection lines used for receiving reflected light from the object and creating a skin detection region used for detecting the skin region integrated therein and configured to receive the reflected light from the object at different timings for each of the plurality of lines and create the picked-up image including at least the skin detection region; control means and to control the first irradiating means, the second irradiating means, and the creating means configured to cause the skin detection lines to be irradiated with the reflected light from the object and create the first picked-up image including at least the skin detection region in a state in which the object is irradiated with the light having the first wavelength, and configured to cause the skin detection lines to be irradiated with the reflected light from the object and create the second picked-up image including at least the skin detection region in a state in which the object is irradiated with the light having the second wavelength, and detecting means configured to detect the skin region on the basis of the first picked-up image and the second picked-up image.

The invention may be configured in such a manner that the image pickup element includes the plurality of lines including the skin detection lines arranged at intervals of n (n is natural numbers) lines, the control means controls the first irradiating means, the second irradiating means, and the creating means to cause the skin detection lines to be irradiated with the reflected light from the object and create the first picked-up image including the skin detection region as a first skin detection image in a state in which the object is irradiated with the light having the first wavelength, and cause the skin detection lines to be irradiated with the reflected light from the object and create the first picked-up image including the skin detection region as a second skin detection image in a state in which the object is irradiated with the light having the second wavelength, and the detecting means detects the skin region on the basis of the first skin detection image and the second skin detection image.

The invention may be configured in such a manner that the control means controls the first irradiating means, the second irradiating means, and the creating means to cause the skin detection lines to be irradiated with the reflected light from the object and create the first picked-up image including the skin detection region in a state in which the object is irradiated with the light having the first wavelength, and cause the skin detection lines to be irradiated with the reflected light from the object and create the second picked-up image including the skin detection region in a state in which the object is irradiated with the light having the second wavelength, and the detection means includes:

extracting means configured to extract the skin detection region included in the first picked-up image as the first extracted image and extract the skin detection region included in the second picked-up image as the second extracted image and

skin region detecting means configured to detect the skin region on the basis of the first and second extracted images.

The invention may be configured in such a manner that the control means controls the first irradiating means, the second irradiating means, and the creating means to cause the skin detection lines to be irradiated with the reflected light from the object for at least a predetermined light-receiving time in a state in which the object is irradiated with the light having the first wavelength, and cause the skin detection lines to be irradiated with the reflected light from the object for at least the predetermined light-receiving time in a state in which the object is irradiated with the light having the second wavelength.

The invention may be configured in such a manner that the creating means images the object in sequence at predetermined image pickup timings to create the picked-up image; and the control means controls the first irradiating means, the second irradiating means, and the creating means to create the first picked-up image at a predetermined image pickup timing and create the second picked-up image at a next image pickup timing of the predetermined image pickup timing.

The invention may be configured in such a manner that the first and second irradiating means emit light having a wavelength of a case where a differential obtained by subtracting the reflectance of the reflected light obtained by irradiating the human skin with the light having the second wavelength from the reflectance of the reflected light obtained by irradiating the same with the light having the first wavelength becomes a predetermined differential threshold value or larger.

The invention may be configured in such a manner that a first wavelength λ1 and a second wavelength λ2 satisfy

640nm≦λ1≦1000nm

900nm≦λ2≦1100nm.

The invention may be configured in such a manner that the first irradiating means irradiates the object with a first infrared ray as the light having the first wavelength, and the second irradiating means irradiates the object with a second infrared ray having a longer wavelength than the first infrared ray as the light having the second wavelength.

The invention may be configured in such a manner that the detecting means detects the skin region on the basis of the luminance value of the first picked-up image and the luminance value of the second picked-up image.

The invention may be configured in such a manner that the skin region detecting means detects the skin region on the basis of the luminance value of the first extracted image and the luminance value of the second extracted image.

An information processing method according to a first aspect of the present invention is an information processing method of an information processing apparatus configured to detect a skin region which indicates human skin from a picked-up image obtained by imaging an object, wherein the information processing apparatus includes: first irradiating means; second irradiating means; creating means; control means; and detecting means, including the steps that the first irradiating means irradiates the object with light having a first wavelength, and the second irradiating means irradiates the objet with light having a second wavelength which is longer than the first wavelength; the creating means includes an image pickup element having a plurality of lines including skin detection lines used for receiving reflected light from the object and creating a skin detection region used for detecting the skin region integrated therein and receives the reflected light from the object at different timings for each of the plurality of lines and creates the picked-up image including at least the skin detection region; the control means controls the first irradiating means, the second irradiating means, and the creating means and causes the skin detection lines to be irradiated with the reflected light from the object and creates the first picked-up image including at least the skin detection region in a state in which the object is irradiated with the light having the first wavelength, and causes the skin detection lines to be irradiated with the reflected light from the object and creates the second picked-up image including at least the skin detection region in a state in which the object is irradiated with the light having the second wavelength, and the detecting means detects the skin region on the basis of the first picked-up image and the second picked-up image.

A program according to a first aspect of the present invention is a program configured to cause a computer of an information processing apparatus configured to detect a skin region which indicates human skin from a picked-up image obtained by imaging an object to function as control means configured to control first irradiating means, second irradiating means, and creating means and to cause skin detection lines to be irradiated with reflected light from the object and create a first picked-up image including at least a skin detection region in a state in which the object is irradiated with light having a first wavelength, and configured to cause the skin detection lines to be irradiated with the reflected light from the object and create a second picked-up image including at least the skin detection region in a state in which the object is irradiated with the light having a second wavelength, and detecting means configured to detect the skin region on the basis of the first picked-up image and the second picked-up image, the information processing apparatus including the first irradiating means configured to irradiate the object with the light having the first wavelength; the second irradiating means configured to irradiate the object with the light having the second wavelength which is longer than the first wavelength; and the creating means including an image pickup element having a plurality of lines including the skin detection lines used for receiving the reflected light from the object and creating the skin detection region used for detecting the skin region integrated therein and configured to receive the reflected light from the object at different timings for each of the plurality of lines and create the picked-up image including at least the skin detection region.

According to the first aspect of the present invention, the first irradiating means, the second irradiating means, and the creating means are controlled and caused the skin detection lines to be irradiated with the reflected light from the object and the first picked-up image including at least the skin detection region is created in a state in which the object is irradiated with the light having the first wavelength, and the skin detection lines are caused to be irradiated with the reflected light from the object and create the second picked-up image including at least the skin detection region is created in a state in which the object is irradiated with the light having the second wavelength. Then, the skin region is detected on the basis of the first picked-up image and the second picked-up image.

An electronic apparatus according to a second aspect of the present invention is an electronic apparatus including an information processing apparatus configured to detect a skin region which indicates human skin from a picked-up image obtained by imaging an object integrated therein, wherein the information processing apparatus includes: first irradiating means configured to irradiate the object with light having a first wavelength; second irradiating means configured to irradiate the object with light having a second wavelength which is longer than the first wavelength; creating means including an image pickup element having a plurality of lines including skin detection lines used for receiving reflected light from the object and creating a skin detection region used for detecting the skin region integrated therein and configured to receive the reflected light from the object at different timings for each of the plurality of lines and create the picked-up image including at least the skin detection region; control means and to control the first irradiating means, the second irradiating means, and the creating means configured to cause the skin detection lines to be irradiated with the reflected light from the object and create the first picked-up image including at least the skin detection region in a state in which the object is irradiated with the light having the first wavelength, and configured to cause the skin detection lines to be irradiated with the reflected light from the object and create the second picked-up image including at least the skin detection region in a state in which the object is irradiated with the light having the second wavelength, and detecting means configured to detect the skin region on the basis of the first picked-up image and the second picked-up image.

According to the second aspect of the present invention, in the information processing apparatus integrated in the electronic apparatus, the first irradiating means, the second irradiating means, and the creating means are controlled and caused the skin detection lines to be irradiated with the reflected light from the object and the first picked-up image including at least the skin detection region is created in a state in which the object is irradiated with the light having the first wavelength, and the skin detection lines are caused to be irradiated with the reflected light from the object and the second picked-up image including at least the skin detection region is created in a state in which the object is irradiated with the light having the second wavelength. Then, the skin region is detected on the basis of the first picked-up image and the second picked-up image.

### Advantages of the Invention

According to the present invention, even when a rolling-shutter-type camera is employed, a skin region can be detected with high degree of accuracy on the basis of first and second picked-up images imaged by a camera by adjusting an exposure time of the camera and an irradiating time of a light-emitting device.

### BRIEF DESCRIPTION OF THE DRAWINGS

FIG. 1 is a block diagram showing an example of a configuration of a skin recognizing system of the related art.

FIG. 2 is a drawing showing an example of an image pickup element configured by a plurality of horizontal lines.

FIG. 3 shows an example of a state of exposure in a case where a global-shutter-type camera is employed.

FIG. 4 is a block diagram showing an example of a configuration of an information processing system according to a first embodiment.

FIG. 5 is a drawing showing an example of a method of adjusting an exposure time and an irradiating time in the first embodiment.

FIG. 6 shows an example when a skin region cannot be detected with high degree of accuracy when a rolling-shutter-type camera is employed.

FIG. 7 is a drawing showing spectral reflectance characteristics of human skin.

FIG. 8 is a drawing for explaining an outline of a process performed by an image processing apparatus shown in FIG. 4.

FIG. 9 is a block diagram showing an example of a configuration of the image processing apparatus shown in FIG. 4.

FIG. 10 is a flowchart for explaining a skin detecting process performed by the information processing system shown in FIG. 4.

FIG. 11 is a block diagram showing an example of the configuration of the information processing system according to a second embodiment.

FIG. 12 is a drawing showing a first example of an image pickup element integrated in a camera shown in FIG. 11.

FIG. 13 is a drawing showing a second example of the image pickup element integrated in the camera shown in FIG. 11.

FIG. 14 is a drawing showing an example of a method of adjusting the exposure time and the irradiating time in the second embodiment.

FIG. 15 is a block diagram showing an example of the configuration of the image processing apparatus shown in FIG. 11.

FIG. 16 is a flowchart for explaining the skin detecting process performed by the information processing system shown in FIG. 11.

FIG. 17 is a block diagram showing an example of a configuration of a computer.

### BEST MODES FOR CARRYING OUT THE INVENTION

Hereinafter, modes for carrying out the invention (hereinafter, referred to as embodiments) will be described. For reference sake, the description is performed in the following order.

1. First Embodiment (an example of when creating a picked-up image including a region used by the camera for skin detection when a rolling-shutter-type camera is employed)

2. Second Embodiment (an example of when creating an image for the skin detection including a region used by a camera for the skin detection when the rolling-shutter-type camera is employed)

3. Modifications

### 1. First Embodiment

### Example of Configuration of Information Processing System 41

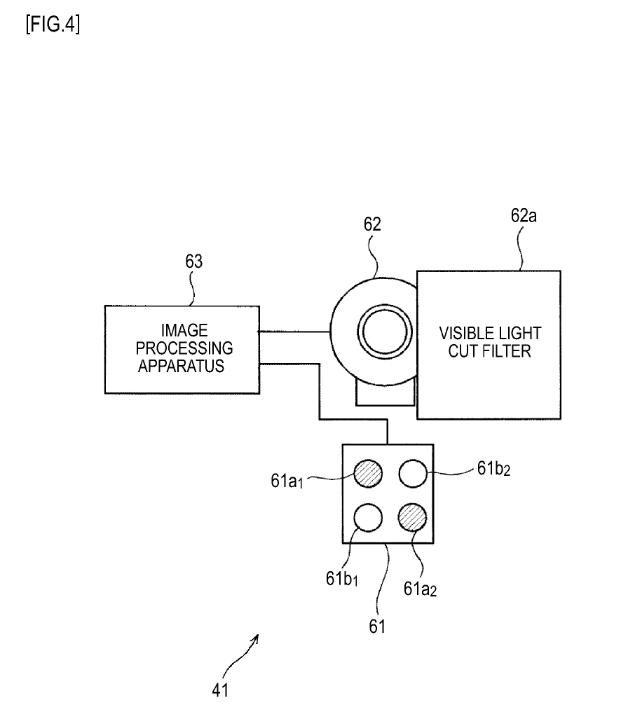

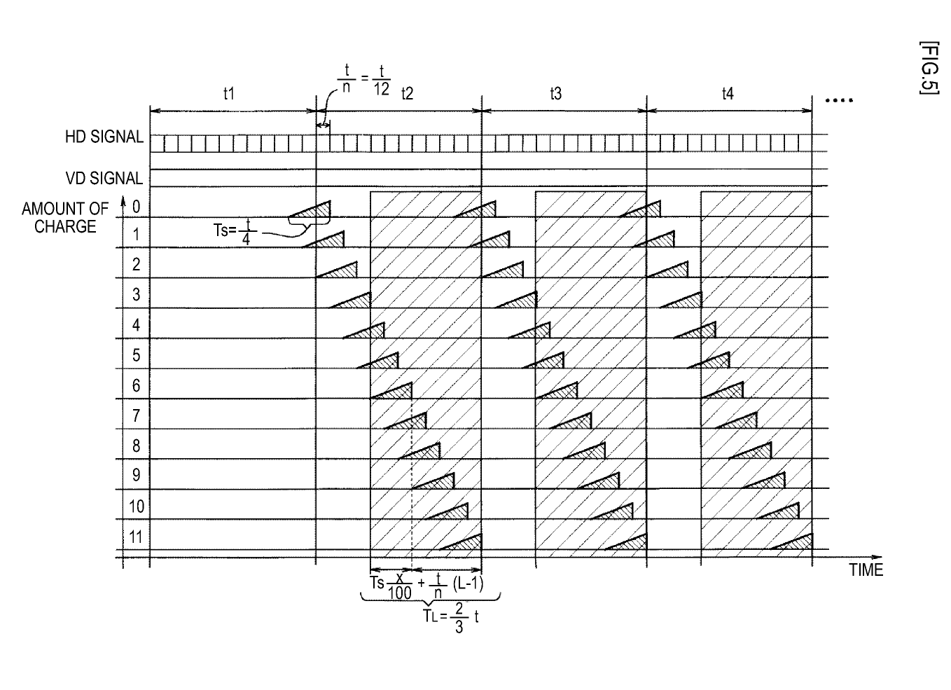

FIG. 4 shows an example of a configuration of an information processing system 41 according to a first embodiment.

The information processing system 41 includes a light-emitting device 61, a camera 62, and an image processing apparatus 63.

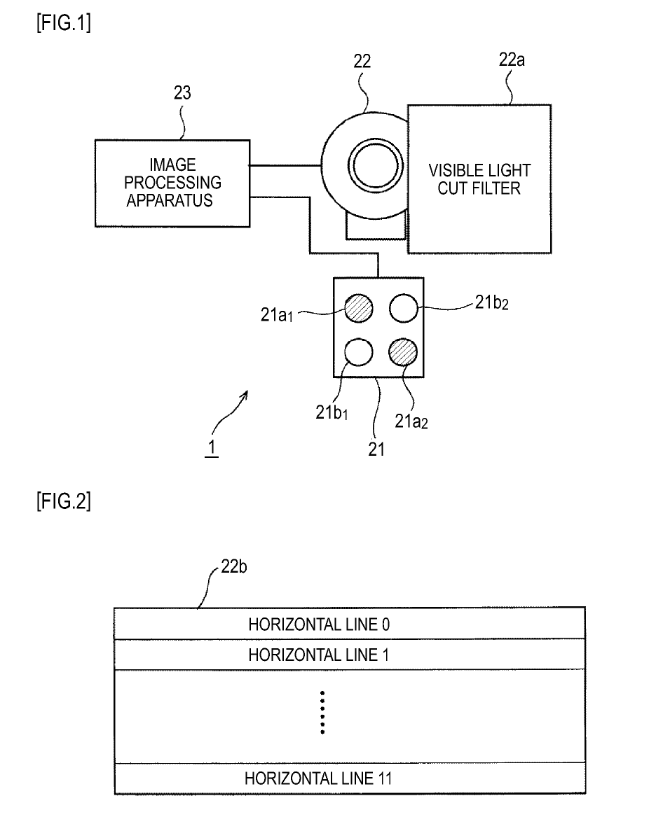

The light-emitting device 61 includes an LED 61a₁ and an LED 61a₂ having the same function as the LED 21a₁ and the LED 21a₂ in FIG. 1 and an LED 61b₁ and an LED 61b₂ having the same function as the LED 21b₁ and the LED 21b₂ in FIG. 1.

In the following description, when there is no necessity to discriminate the LED 61a₁ and the LED 61a₂, the LED 61a₁ and the LED 61a₂ are expressed simply as LED 61a. Also, when there is no necessity to discriminate the LED 61b₁ and the LED 61b₂, the LED 61b₁ and the LED 61b₂ are expressed simply as LEDs 61b. Here, the number of the LEDs 61a is not limited to two, and is determined as needed so that an object is irradiated with required light beams as evenly as possible. Much the same is true on the LEDs 61b.

The LEDs 61a irradiate the object with the light beams having a wavelength λ1. The LEDs 61b irradiate the object with the light beams having a wavelength λ2 which is different from the wavelength λ1. In this case, the wavelength λ2 is assumed to be longer than the wavelength λ1.

The camera 62 is a rolling-shutter-type camera having an image pickup element integrated therein and configured to receive reflected light from the object and perform exposure which receives reflected light from the object at different timings for each of a plurality of horizontal lines which constitute the integrated image pickup element.

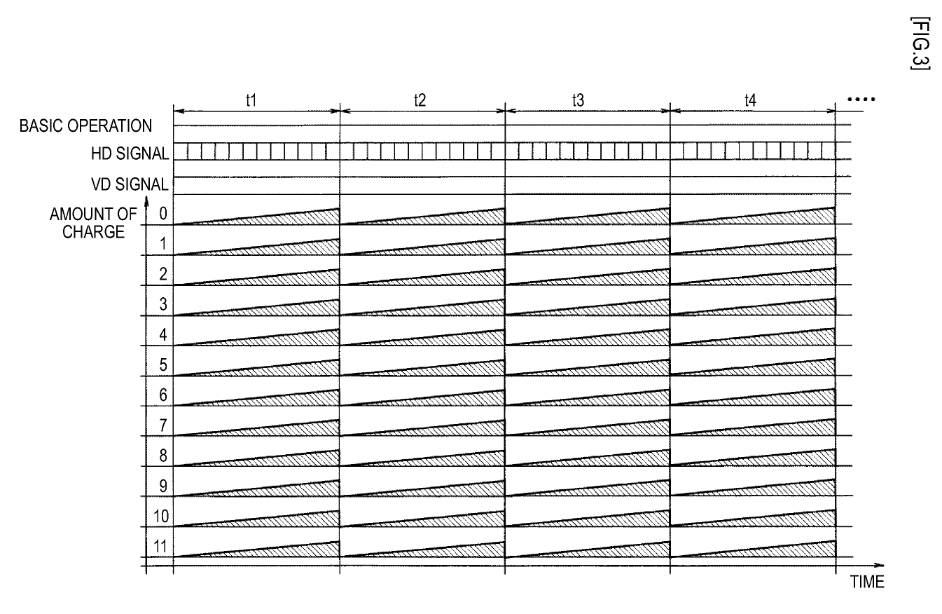

The image pickup element integrated in the camera 62 is described as including a plurality of horizontal lines 0 to 11 in the same manner as in the case shown in FIG. 2. However, the number of horizontal lines is not limited thereto.

In addition, the horizontal lines 0 to 11 which constitute the image pickup element integrated in the camera 62 only have to be arranged in parallel to each other and, needless to say, are not meant to be arranged horizontally with respect to the ground.

Also, the camera 62 has a lens used for imaging of the object such as a user, and a front surface of the lens is covered with a visible light beam cut filter 62a which shields visible light beam.

Therefore, except for sunlight or invisible light components such as fluorescent light, the camera 62 receives only the reflected light of the invisible light with which the object is irradiated by the light-emitting device 61, and the picked-up image obtained thereby is supplied to the image processing apparatus 63.

The camera 62 images the object, and supplies the picked-up image obtained thereby to the image processing apparatus 63.

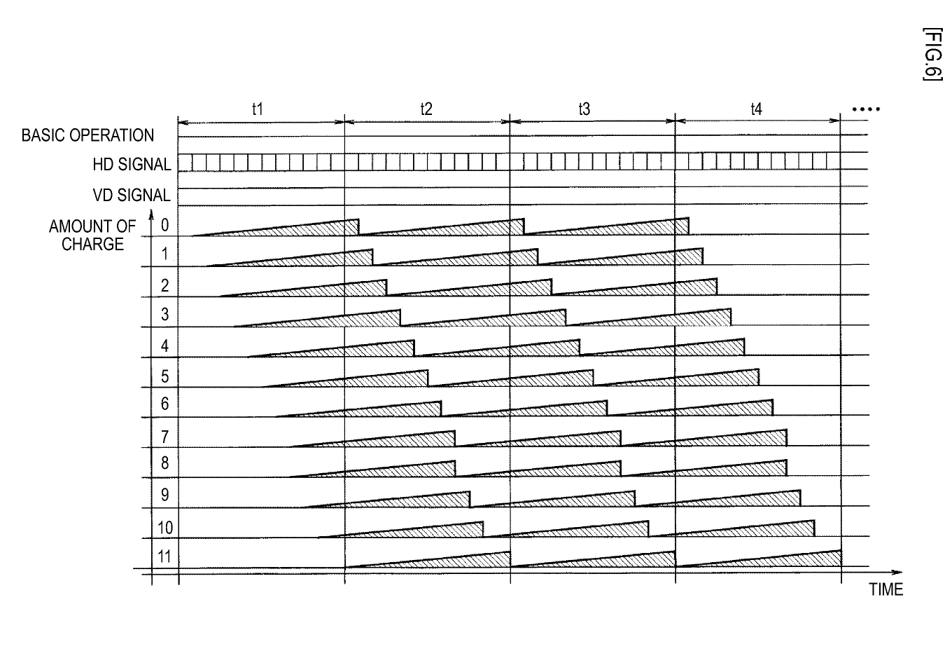

The camera 62 starts imaging of the object in sequence at predetermined imaging timings (at intervals of a time t in FIG. 5, described later), and creates a picked-up image by the imaging.

The image processing apparatus 63 generates a VD signal and an HD signal, and controls the light-emitting device 61 and the camera 62 on the basis of the generated VD signal and HD signal.

In other words, the image processing apparatus 63 adjusts an irradiating time TL for irradiating respectively with the light beams having the wavelength λ1 or λ2 and an exposure time Ts of each of the respective horizontal lines 0 to 11 so that only the reflected light having one of the wavelengths λ1 and λ2 in a plurality of horizontal lines which constitutes the image pickup element of the camera 62 is received in the horizontal lines which constitute the image pickup element.

### [Method of Adjusting Irradiating Time TL and Exposure Time Ts]

Referring now to FIG. 5, a method of adjusting the irradiating time TL and the exposure time Ts performed by the image processing apparatus 63 will be described.

The numerals 0 to 11 shown on the left side in FIG. 5 indicate the twelve horizontal lines 0 toll which constitute the image pickup element integrated in the rolling-shutter-type camera, respectively.

In FIG. 5, the times t1, t2, t3, t4, . . . indicate intervals of appearance of the rising edges of the VD signal, and the sign t/12 designates an interval of appearance of rising edges of the HD signal.

In addition, as regards the right-angled triangles (indicated by hatching) in FIG. 5, the lateral length indicates the exposure time Ts in which the exposure is performed in the horizontal lines which constitute the image pickup element integrated in the rolling-shutter-type camera, and the vertical length (height) indicates the amount of charge therein.

In the first embodiment, when the rolling-shutter-type camera is used, the irradiating time TL for irradiating the light beams having one of the wavelengths λ1 and λ2 and the exposure time Ts are adjusted so that only the reflected light having one of these wavelengths is received in the horizontal lines which constitute the image pickup element of the camera 62.

In other words, for example, as shown in FIG. 5, the irradiating time TL and the exposure time Ts are adjusted so that the reflected light having one of the wavelengths is received by the horizontal lines 6 to 11 from among the plurality of horizontal lines 0 to 11 for at least the minimum exposure time (Ts×x/100) required for the skin detection.

When it is required to receive the reflected light from the object having the wavelength λ1 for at least a first light-receiving time and the reflected light from the object having the wavelength λ2 for at least a second light-receiving time in order to allow the skin detection, if the first light-receiving time and the second light-receiving time are different, the longer one of the first and second light-receiving time is employed as the above-described exposure time (Ts×x/100).

The sign x indicates values from 0 to 100, and varies according to the amount of irradiating light beams from the LEDs 61a and the LEDs 61b or the light-receiving sensitivity characteristics or the like of the camera 62.

Now, if the minimum exposure time (Ts×x/100) required for the skin detection is Ts (x=100), the irradiating time TL and the exposure time Ts are adjusted to satisfy the following expression (1).

TL≧(6−1)×t/12+Ts×100/100 (1)

When the expression (1) is modified, the following expression (2) is obtained.

TL≧5t/12+Ts (2)

Then, as a combination (TL, Ts) of the irradiating time TL and the exposure time Ts which satisfy the expression (2) for example, (TL, Ts)=(2t/3, t/4) can be employed.

For reference sake, the expression (1) can be generalized to the following expression (3),

TL≧(L−1)×t/n+Ts×x/100 (3)

where L represents the total number 6 of the horizontal lines 6 to 11 which receives the reflected light having one of the wavelengths for at least the minimum exposure time (Ts×x/100) required for the skin detection, and n represents the total number 12 of the plurality of horizontal lines 0 to 11. Tn other words, variables L, n, x are determined in advance depending on the performances of the camera 62, or the enterprises which produce the information processing system 41. Then, the values (TL, Ts) are determined on the basis of the expression (3) obtained by substituting the determined L, n, x.

The description of the first embodiment will be given below assuming that L=6, n=12, x=100, and (TL, Ts)=(2t/3, t/4) are employed.

The image processing apparatus 63 controls the LEDs 61a to irradiate the object with the light beams having the wavelength λ1 for the irradiating time TL in the time t2.

Then, the image processing apparatus 63 controls the camera 62, and causes the horizontal lines 6 to 11 from among the plurality of horizontal lines 0 to 11 which constitute the image pickup element integrated in the camera 62 to be irradiated with the reflected light reflected when the object is irradiated with the light beams having the wavelength λ1 for the minimum exposure time Ts required for the skin detection. Accordingly, the camera 62 creates a first picked-up image and supplies the same to the image processing apparatus 63.

Also, the image processing apparatus 63 controls the LEDs 61b to irradiate the object with the light beams having the wavelength λ2 for the irradiating time TL in the time t3.

Then, the image processing apparatus 63 controls the camera 62, and causes the horizontal lines 6 to 11 from among the plurality of horizontal lines 0 to 11 which constitute the image pickup element integrated in the camera 62 to be irradiated with the reflected light reflected when the object is irradiated with the light beams having the wavelength λ2 for the minimum exposure time Ts required for the skin detection. Accordingly, the camera 62 creates a second picked-up image and supplies the same to the image processing apparatus 63.

The first and second picked-up images in the first embodiment are different from the first and second picked-up images described with reference to FIG. 1 to FIG. 3.

The image processing apparatus 63 extracts a region obtained from the horizontal lines 6 to 11 which receive the reflected light having the wavelength λ1 from among the total region which constitutes the first picked-up image supplied from the camera 62 (the region obtained from the horizontal lines 0 to 11) as a first extracted image.

Also, the image processing apparatus 63 extracts a region obtained from the horizontal lines 6 to 11 which receive the reflected light having the wavelength λ2 from among the total region which constitutes the second picked-up image supplied from the camera 62 (the region obtained from the horizontal lines 0 to 11) as a second extracted image.

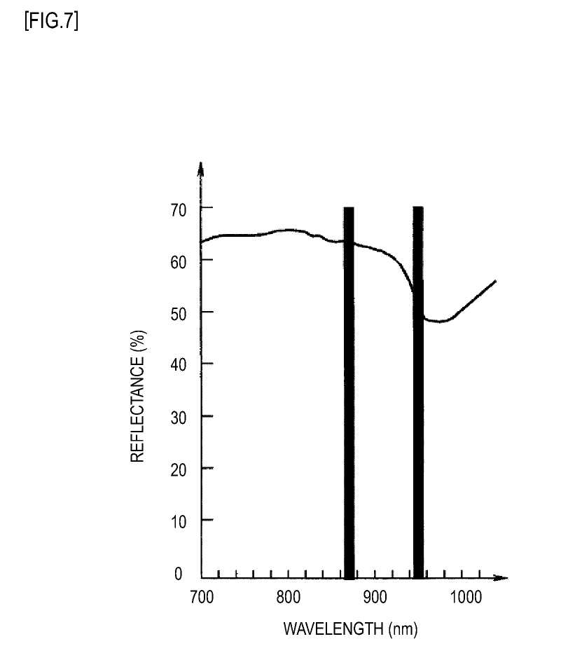

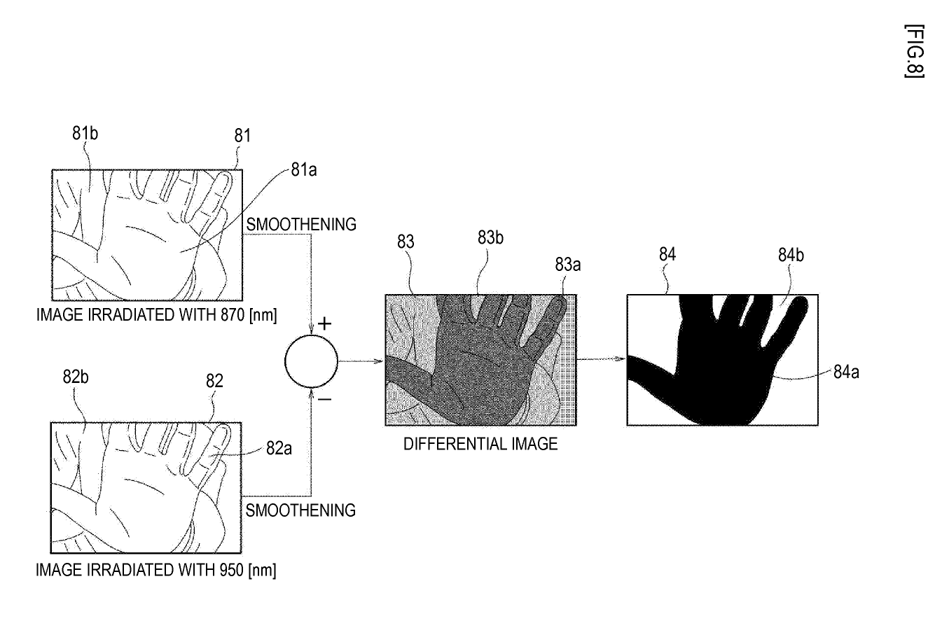

Then, the image processing apparatus 63 detects a skin region on the first or the second extracted images on the basis of the extracted first and second extracted images. The skin detection region by the image processing apparatus 63 will be described later with reference to FIG. 7 to FIG. 9.

In this manner, in the information processing system 41, when the rolling-shutter-type camera is employed as the camera 62, the image processing apparatus 63 adjusts the irradiating time TL and the exposure time Ts by the adjusting method described above, unlike the image processing apparatus 23 of the skin recognizing system 1 of the related art.

The image processing apparatus 63 extracts the first extracted image from the first picked-up image supplied from the camera 62 and extracts the second extracted image from the second picked-up image supplied from the camera 62.

Then, the image processing apparatus 63 detects the skin region on the basis of the extracted first and second picked-up images.

It is for the skin detection region with high degree of accuracy also when the rolling-shutter-type camera is employed as the camera 62 in the information processing system 41.

Subsequently, FIG. 6 shows an example in which the skin region cannot be detected with high degree of accuracy when the information processing system 41 which employs the rolling-shutter-type camera as the camera 62 detects the skin region by the same process as the skin recognizing system 1 of the related art.

FIG. 6 is configured in the same manner as FIG. 3, and hence the description is omitted.

For example, the LEDs 61a irradiate the object with the light beams having the wavelength λ1 for an irradiating time t1. For example, the LEDs 61b irradiate the object with the light beams having the wavelength λ2 for an irradiating time t2.

In addition, the camera 62 performs the exposure of the horizontal lines 0 to 11, respectively, which constitute the image pickup element integrated therein, at different timings. In other words, for example, the camera 62 starts exposure every time when the rising edge appears in the HD signal generated by the image processing apparatus 63 in ascending order from the horizontal lines 0 to 11.

In this case, as shown in FIG. 6, the exposure of the respective horizontal line 0 to 10 from among the horizontal lines 0 to 11 which constitute the image pickup device is performed across the irradiating time for irradiating the light beam having the wavelength λ1 (for example, the irradiating time t1) to the irradiating time for irradiating the light beam having the wavelength λ2 (for example, the irradiating time t2).

Therefore, the amount of charge obtained by the exposure for the respective horizontal lines 0 to 10 from among the horizontal lines 0 to 11 which constitute the image pickup element is obtained by receiving the reflected light reflected when the object is irradiated by the light beam having the wavelength λ1 and the reflected light reflected when the object is irradiated with the light beam having the wavelength λ2.

Therefore, when the rolling-shutter-type camera is employed, the camera 62 creates the first and second picked-up images used for the skin detection region on the basis of the amount of charge obtained by receiving the reflected light reflected when the object is irradiated with the light beam having the wavelength λ1 and the reflected light reflected when the object is irradiated with the light beam having the wavelength λ2, and supplies the same to the image processing apparatus 63.

In this case, the image processing apparatus 63 detects the skin region on the basis of the first picked-up image obtained by receiving the reflected light having the wavelength λ1 and the reflected light having the wavelength λ2 and the second picked-up image obtained by receiving the reflected light having the wavelength λ1 and the reflected light having the wavelength λ2.

Therefore, the image processing apparatus 63 has a difficulty to detect the skin region using the difference in reflection ratio between the wavelength λ1 and the wavelength λ2, and hence the accuracy to detect the skin region is significantly lowered.

Accordingly, the image processing apparatus 63 adjusts the irradiating time TL and the exposure time Ts as described above, and detects the skin region on the basis of the extracted first and second extracted images. Accordingly, the skin region can be detected with high degree of accuracy also when the rolling-shutter-type camera is employed as the camera 62 in the information processing system 41.

### [Process to be Performed by Image Processing Apparatus 63]

Subsequently, a process performed by the image processing apparatus 63 will be described with reference to FIG. 7 to FIG. 9.

[Spectral Reflectance Characteristics with Respect to Skin]

FIG. 7 shows spectral reflectance characteristics for the human skin.

The spectral reflectance characteristics have generality irrespective of the difference in color of the human skin (difference in race) or the states (suntan or the like).

In FIG. 7, the lateral axis indicates the wavelength of the irradiating light beam that the human skin is irradiated with, and the vertical axis indicates the reflectance of the irradiating light beam that the human skin is irradiated with.

It is known that the reflectance of the irradiating light beam that the human skin is irradiated with has a peak near 800 [nm], then is lowered abruptly from a point near 900 [nm], and is increased again from a point near 1000 [nm] as a smallest value.

More specifically, as shown in FIG. 7 for example, the reflectance of the reflected light obtained by irradiating the human skin with a light beam of 870 [nm] is 63[%], and the reflectance of the reflected light obtained by irradiating the same with a light beam of 950 [nm] is 50[%].

This is specific for the human skin, and a change in reflection ratio is gentle near the wavelengths from 800 to 1000 [nm] in the case of the substances other than the human skin (for example, hair or clothes) in many cases.

In the first embodiment, in the above-described spectral reflectance characteristics, a combination of a wavelength λ1 of 870 [nm] and a wavelength λ2 of 950 [nm] are employed as a combination of the wavelengths λ1 and λ2. This combination is a combination in which the difference in reflectance with respect to the human skin becomes relatively large, and also a combination in which the difference in reflectance with respect to portions other than the human skin becomes relatively small.

Also, the first extracted image is configured with a region obtained by receiving only the reflected light reflected when the object is irradiated with the light beam having the wavelength λ1. In addition, the second extracted image is configured with a region obtained by receiving only the reflected light reflected when the object is irradiated with the light beam having the wavelength λ2.

Therefore, the differential absolute values between the luminance values of pixels which constitute the skin region on the first extracted image and the luminance values which constitute the skin region on the corresponding second extracted image are a relatively large values corresponding to the difference in reflectance with respect to the human skin.

Also, the differential absolute values between the luminance values of pixels which constitute a non-skin region (a region other than the skin region) on the first extracted image and the luminance values which constitute the non-skin region on the corresponding second extracted image are relatively small values corresponding to the difference in reflectance with respect to the portion other than the human skin.

### [Outline of Process Performed by Image Processing Apparatus 63]

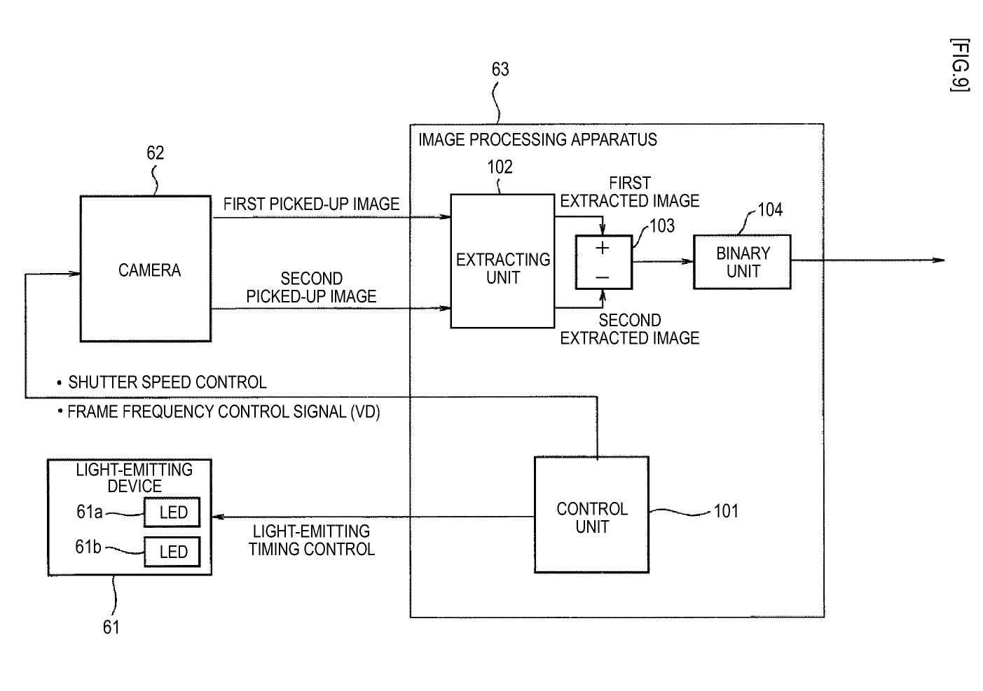

FIG. 8 shows an outline of the process performed by the image processing apparatus 63.

The first and second picked-up images are supplied from the camera 62 to the image processing apparatus 63. The image processing apparatus 63 extracts a first extracted image 81 configured with a skin region 81a and a non-skin region 81b (the region other than the skin region 81a) from the first picked-up image supplied from the camera 62.

Also, the image processing apparatus 63 extracts a second extracted image 82 configured with a skin region 82a and a non-skin region 82b (the region other than the skin region 82a) from the first picked-up image supplied from the camera 62.

The image processing apparatus 63 smoothens the extracted first extracted image 81 and second extracted image 82 using an LPF (low pass filter). Then, the image processing apparatus 63 calculates differential absolute values between the luminance values of corresponding pixels between the first extracted image 81 after the smoothening and the second extracted image 82 after the smoothening, and creates a differential image 83 having the differential absolute values as the pixel values.

The image processing apparatus 63 is configured to smoothen the first extracted image 81 and the second extracted image 82 using the LPF. However, the timing to perform the smoothening is not limited thereto. In other words, for example, the image processing apparatus 63 may be configured to smoothen the first and second picked-up images supplied from the camera 62 using the LPF.

The image processing apparatus 63 binarizes the created differential image 83 by setting the pixel values equal to or larger than a predetermined threshold value from among the pixel values which constitute the differential image 83 are set to “1” and the pixel values smaller than the predetermined threshold value are set to “0”.

In this case, the skin region 83a in the differential image 83 is configured with pixels having differential absolute values between the skin region 81a and the skin region 82a as pixel values, and hence the pixel values of the pixels constituting the skin region 83a are relatively large values.

In this case, the non-skin region 83b in the differential image 83 is configured with pixels having differential absolute values between the non-skin region 81b and the non-skin region 82b as pixel values, and hence the pixel values of the pixels constituting the non-skin region 83b are relatively small values.

Therefore, the differential image 83 is converted into a binary image 84 including a skin region 84a whose pixel values of the pixels which constitute a skin region 83a are set to “1” and a non-skin region 84b whose pixel values of the pixels which constitute a non-skin region 83b are set to “0” by the binarization performed by the image processing apparatus 63.

The image processing apparatus 63 detects the skin region 84a configured with the pixels having the pixel value of “1” from among the pixels which constitute the binary image 84 obtained by binarizing as a skin region.

In this manner, the image processing apparatus 63 is configured to detect the skin region according to whether or not a differential absolute value |Y1−Y2| (corresponding to the pixel value of the differential image 83) between a luminance value Y1 of the first extracted image 81 after the smoothening and a luminance value Y2 of the second extracted image 82 after smoothening is a predetermined threshold value or higher. However, the method of detecting the skin region is not limited thereto.

Here, for example, it is known that the differential absolute values of the reflectances at the wavelengths λ1 and λ2 are relatively large in the case of the human hair. Therefore, when detecting the skin region on the basis of the differential absolute value |Y1−Y2|, the hair may be erroneously detected as the skin.

In order to detect the skin more accurately as distinguished from the hair, it is preferable to create the differential image 83 having the differential obtained by subtracting the luminance value Y2 from the luminance value Y1 (Y1−Y2) and detect the skin region according to whether or not the pixel value (Y1−Y2) of the differential image 83 is a predetermined threshold value or larger.

When there is no irradiation unevenness in the irradiation of the object with the light beams having the wavelengths λ1 and λ2, a fixed threshold value can be used as the threshold value to be used for the detection of the skin region. However, when there is an irradiation unevenness in the irradiation of light beams having the wavelengths λ1 and λ2, the differential absolute values |Y1−Y2| and the threshold value to be compared with the differential (Y1−Y2) need to be dynamically changed according to the state of the irradiation unevenness.

In this case, the image processing apparatus 63 is required to perform a complicated process such as determining whether or not the irradiation unevenness is generated, and changing the threshold value dynamically according to the state of the irradiation unevenness. Therefore, the threshold value used for the detection of the skin region is preferably always a fixed threshold value irrespective of the irradiation unevenness.

Therefore, for example, it is also possible to normalize (divide) the differential absolute value |Y1−Y2| or the differential (Y1−Y2) by a division value and then compare the same with the predetermined threshold value, and detect the skin region. In this case, the predetermined threshold value may be a fixed threshold value irrespective of the irradiation unevenness.

Here, the dividing value represents a value on the basis of at least one of the luminance value Y1 or Y2 and, for example, the luminance value Y1, the luminance value Y2, an average value of the luminance values Y1 and Y2 {(Y1+Y2)/2} may be employed.

For example, a configuration in which the skin region is detected on the basis of whether or not the ratio Y2/Y1, for example, is a predetermined threshold value or larger as a ratio between the luminance value Y1 and the luminance value Y2 is also applicable. In this case, the fixed threshold can be used in the same manner irrespective of the irradiation unevenness. What is required is only to calculate the ratio Y2/Y1, and hence the value to be compared with the predetermined threshold value can be calculated more quickly than the case where the differential absolute value |Y1−Y2| or the differential (Y1−Y2) is calculated and normalizes the same. Therefore, the process of detecting the skin region more quickly can be performed.

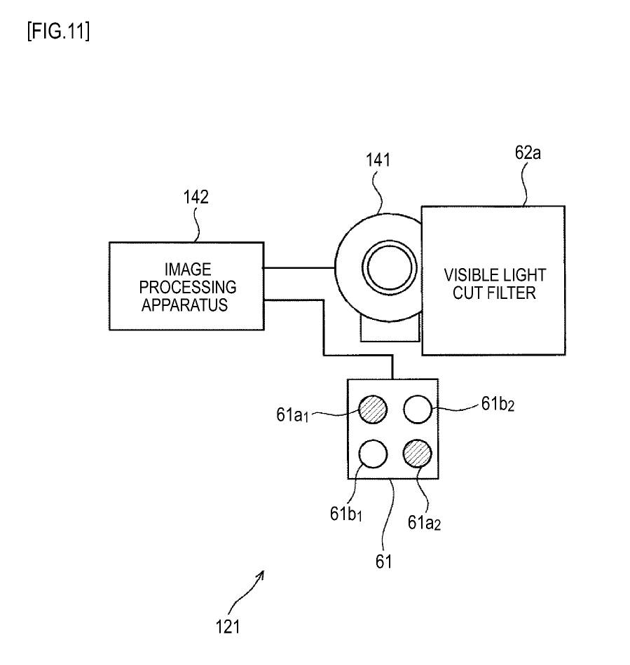

In the first embodiment, the image processing apparatus 63 is described as detecting the skin region according to whether or not the differential absolute value |Y1−Y2| is a predetermined threshold value or larger. This is the same in a second embodiment described later. The second embodiment will be described with reference to FIG. 11 to FIG. 16.

### [Example of Configuration of Image Processing Apparatus 63]

FIG. 9 shows an example of a configuration of the image processing apparatus 63.

The image processing apparatus 63 includes a control unit 101, an extracting unit 102, a calculating unit 103, and a binary unit 104.

The control unit 101 controls the light-emitting device 61 to cause the LEDs 61a and the LEDs 61b of the light-emitting device 61 to emit light beams (irradiate) alternately. In other words, for example, the control unit 101 causes the LEDs 61a to irradiate the object with light beams having the wavelength λ1 in the times t2, t4, . . . for the irradiating time TL (the time from the start of exposure for the horizontal line 6 to the termination of the exposure for the horizontal line 11).

For example, the control unit 101 causes the LEDs 61b to irradiate the object with light beams having the wavelength λ2 in the times t3, t5, . . . for the irradiating time TL.

The control unit 101 controls the camera 62 to image the object by causing the horizontal lines 0 to 11 which constitute the image pickup element integrated in the camera 62 to be exposed for the exposure time Ts from timings when the rising edges of the HD signal are detected in ascending order.

The first and second picked-up images are supplied from the camera 62 to the extracting unit 102. The extracting unit 102 extracts a region obtained from the horizontal lines 6 to 11 for creating a region used for the skin detection from the entire region which constitutes the first picked-up image from the camera 62 as the first extracted image, and supplies the same to the calculating unit 103.

Also, the extracting unit 102 extracts a region obtained from the horizontal lines 6 to 11 for creating a region used for the skin detection from the entire region which constitutes the second picked-up image from the camera 62 as the second extracted image, and supplies the same to the calculating unit 103.

The calculating unit 103 smoothens the first and second extracted images from the extracting unit 102 using the LPF.

Then, the calculating unit 103 calculates differential absolute values between the first and second extracted images after the smoothening, and supplies a differential image configured with pixels having the calculated differential absolute values as pixel values to the binary unit 104.

The binary unit 104 binarizes the differential image from the calculating unit 103 and, on the basis of a binarized image obtained thereby, detects the skin region on the first extracted image (or the second extracted image) and outputs the detected result.

### [Description on Operation of Information Processing System 41]

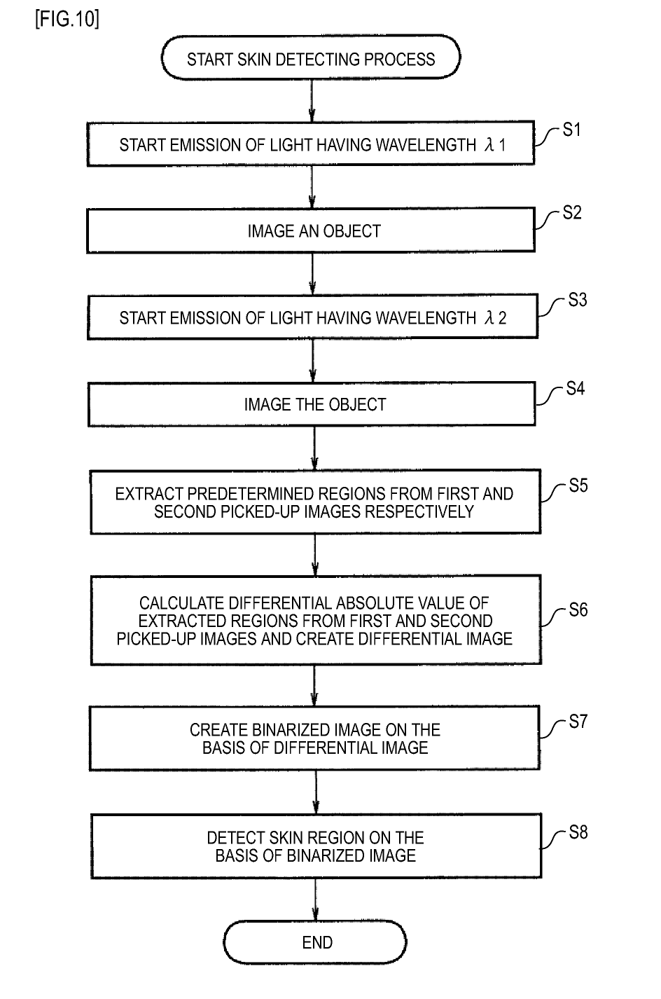

Subsequently, a skin detecting process performed by the information processing system 41 will be described with reference to a flowchart in FIG. 10.

This skin detecting process is performed repeatedly, for example, from when a power source of the information processing system 41 is turned on.

In step S1, the control unit 101 controls the LEDs 61a of the light-emitting device 61, and causes the LEDs 61a to irradiate the object with light beams having the wavelength λ1 in the times t2, t4, . . . for the irradiating time TL.

In Step S2, the camera 62 performs exposure for the exposure time Ts from the timings when the rising edges of the HD signal are detected for each of the horizontal lines 0 to 11 which constitute the image pickup element integrated therein, and supplies the first picked-up image obtained thereby to the extracting unit 102 of the image processing apparatus 63.

In Step S3, the control unit 101 controls the LEDs 61b of the light-emitting device 61, and causes the LEDs 61b to irradiate the object with light beams having the wavelength λ2 in the times t3, t5, . . . for the irradiating time TL.

In Step S4, the camera 62 performs exposure for the exposure time Ts from the timings when the rising edges of the HD signal are detected for each of the horizontal lines 0 to 11 which constitute the image pickup element integrated therein and supplies the second picked-up image obtained thereby to the extracting unit 102.

In Step S5, the extracting unit 102 extracts a region obtained from the horizontal lines 6 to 11 for creating a region used for the skin detection from the entire region which constitutes the first picked-up image from the camera 62 as the first extracted image, and supplies the same to the calculating unit 103.

Also, the extracting unit 102 extracts a region obtained from the horizontal lines 6 to 11 for creating a region used for the skin detection from the entire region which constitutes the second picked-up image from the camera 62 as the second extracted image, and supplies the same to the calculating unit 103.

In Step S6, the calculating unit 103 smoothens the first and second extracted images supplied from the extracting unit 102 using the LPF. Then, the calculating unit 103 creates the differential image on the basis of the differential absolute values between the luminance values of the corresponding pixels of the first and second extracted images after the smoothening, and supplies the same to the binary unit 104.

In Step S7, the binary unit 104 binarizes the differential image supplied from the calculating unit 103. Then, in Step S8, the binary unit 104 detects the skin region from the binary image obtained by binarization. The skin detecting process in FIG. 10 is now terminated.

As described above, according to the skin detecting process in FIG. 10, the first and second picked-up images are configured to be imaged in the irradiating time TL and the exposure time Ts which satisfy the expression (2) (or the expression (3).

Also, in the skin detecting process in FIG. 10, the region obtained by receiving only the reflected light reflected when the object is irradiated with the light beam having the wavelength λ1 is configured to be extracted from the entire region which constitutes the first picked-up image as the first extracted image. In addition, in the skin detecting process in FIG. 10, the region obtained by receiving only the reflected light reflected when the object is irradiated with the light beam having the wavelength λ2 is configured to be extracted from the entire region which constitutes the second picked-up image as the second extracted image.

Then, in the skin detecting process in FIG. 10, the skin region is configured to be detected using the difference in reflection ratio between the wavelength λ1 and the wavelength λ2 on the basis of the extracted first and second extracted images. Therefore, the skin region can be detected with high degree of accuracy also when the rolling-shutter-type camera is employed as the camera 62.

In the skin detecting process in FIG. 10, many types of cameras are distributed as the camera 62 in comparison with the global-shutter-type camera, and the skin region is configured to be detected using the information processing system 41 in which the rolling-shutter-type camera available at a price as low as approximately 1/10 is employed.

Therefore, for example, the camera to be used can be selected from many types of cameras and the production cost of the information processing system 41 may be suppressed to a low level in comparison with the case where the global-shutter-type camera is employed as the camera 62.

In the first embodiment, the region obtained by the horizontal lines 6 to 11 is configured to be extracted as the first and second extracted images. However, the region extracted as the first or second extracted image is not limited thereto, and other regions, for example, regions obtained by the horizontal lines 3 to 8 may be extracted.

In this case, the LEDs 61a emit the light beams in the irradiating time TL from the timing when the exposure in the horizontal line 3 is started to the timing when the exposure in the horizontal line 8 is terminated from among the horizontal lines 0 to 11 which constitute the image pickup element integrated in the camera 62. Much the same is true on the LEDs 61b.

Therefore, in the first and second picked-up images, by determining the horizontal lines corresponding to the regions to be extracted so that the region from which the skin region is detected statistically with high probability, the skin region is included more likely in the first and second extracted images, so that the skin region can be detected with higher degree of accuracy.

As alternatives, for example, in the first embodiment, the region obtained by the horizontal lines 6, 8, may be extracted instead of extracting the region obtained by the horizontal lines 6 to 11 from among the horizontal lines 0 to 11 as the first and second extracted images.

In this manner, in the first embodiment, the image processing apparatus 63 may extract any regions in the first and second picked-up images as the first and second extracted images used to detect the skin region.

### 2. Second Embodiment

Incidentally, in the first embodiment, the image processing apparatus 63 is configured to detect the skin region on the basis of the first and second extracted images (obtained by the horizontal lines 6 to 11 from among the horizontal lines 0 to 11) extracted from the first and second picked-up images, respectively. In this example, the region of the horizontal lines 0 to 5 from among the horizontal lines 0 to 11 cannot be used for the detection of the skin region. It is equivalent to that an approximately upper half of the picked-up image cannot be used for the detection of the skin region and the angle of field of the image pickup element is reduced to a half. In the second embodiment, an example in which the detection of the skin region is performed while maintaining the original angle of field of the image pickup element will be shown.

In other words, for example, a configuration is changed to use only six horizontal lines selected alternately from among the twelve horizontal lines (horizontal lines 0 to 11) which constitute the image pickup element of a camera 141 (FIG. 11). Then, the camera 141 may be configured to create first and second skin detection images (corresponding to the first and second extracted images) used in the detection of the skin region directly, and detect the skin region on the basis of the created first and second skin detection images.

Subsequently, FIG. 11 shows an example of an information processing system 121 in which the skin region is detected directly from the first and second skin detection images obtained by the imaging of the object.

Parts of the information processing system 121 configured in the same manner as the information processing system 41 in the first embodiment are designated by the same reference numerals and hence the description thereof will be omitted as needed.

In other words, the information processing system 121 is configured in the same manner as the information processing system 41 according to the first embodiment except that the camera 141 and an image processing apparatus 142 are provided instead of the camera 62 and the image processing apparatus 63 of the information processing system 41.

The camera 141 is the rolling-shutter-type camera having the image pickup element configured to receive the reflected light from the object integrated therein and perform exposure which receives the reflected light from the object at the different timings for the plurality of horizontal lines which constitute the integrated image pickup element.

The camera 141 is driven in a mode which creates an image including a region obtained only by the six horizontal lines used for the detection of the skin region from among the twelve horizontal lines when receiving the reflected light from the object and performing exposure. Therefore, the camera 141 creates the first and second skin detection images including six of the horizontal images obtained by six of the horizontal lines used for the detection of the skin region, respectively.

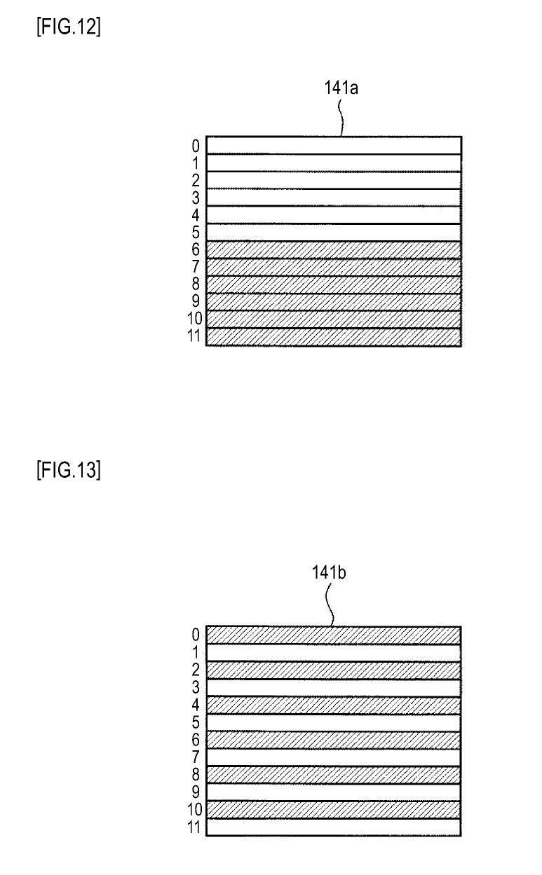

FIG. 12 shows an image pickup element 141a integrated in the camera 141 when using the region obtained by the horizontal lines 6 to 11 that receive the reflected light from the object as the first and second skin detection images (corresponding to the first and second extracted images). In this case, as shown by hatching in FIG. 12, only the horizontal lines 6 to 11 from among the horizontal lines 0 to 11 are used for the skin detection.

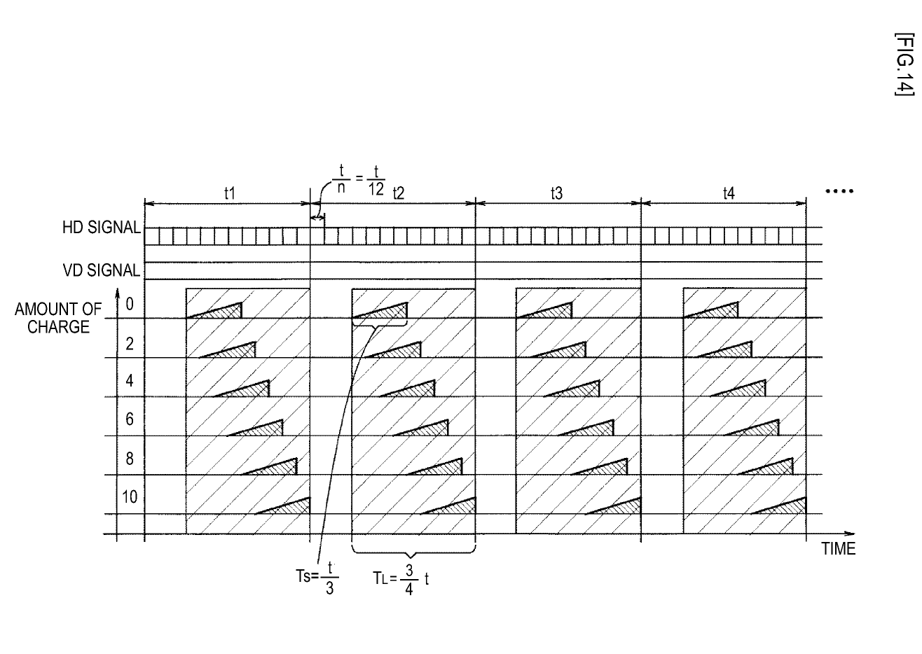

Subsequently, FIG. 13 shows an image pickup element 141b integrated in the camera 141 when using the region obtained by the horizontal lines 0, 2, 4, 6, 8, 10 that receive the reflected light from the object as the first and second skin detection images in the second embodiment. In this case, as shown in FIG. 13, the horizontal lines 0, 2, 4, 6, 8, 10 from among the horizontal lines 0 to 11 are used for the skin detection.

When compared with FIG. 12, the number of the horizontal lines used for the skin detection is the same. However, there is an advantage such that the angle of field of the image pickup element at the time of the skin detection is not reduced in FIG. 13. Although the resolution of the picked-up image is reduced correspondingly, it is important to get the shape or the movement of the skin region to a certain accuracy in the skin detection, and widening of the angle of field in which the skin can be detected has a priority to the image quality in many cases.

In the following description, the camera 141 will be described assuming that the image pickup element 141b is driven as shown in FIG. 13. The picked-up image imaged by the image pickup element 141b may be configured with the horizontal lines in which only the n-horizontal lines are different (n is two or larger natural numbers) in addition to the horizontal lines 0, 2, 4, 6, 8, 10 (or 1 3, 5, 7, 9, 11) in which only one horizontal line is different, for example.

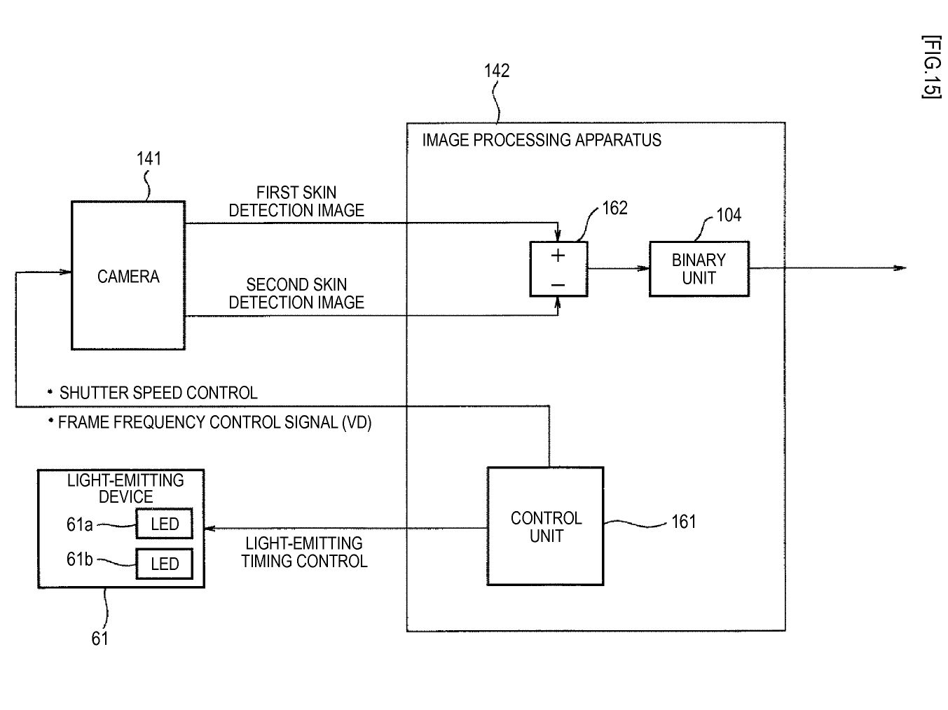

The camera 141 starts imaging of the object in sequence at predetermined imaging timings (at intervals of the time t in FIG. 14, described later), and supplies the first or the second skin detection images obtained thereby to the image processing apparatus 142.

In other words, for example, the camera 141 supplies the first skin detection image obtained when the object is irradiated with the light beam having the wavelength λ1 and the second skin detection image obtained when the object is irradiated with the light beam having the wavelength λ2 to the image processing apparatus 142, respectively.

The image processing apparatus 142 controls the camera 141, receives the VD signal and the HD signal from the camera 141, and controls the light-emitting device 61 on the basis of the received VD signal and HD signal.

In other words, the image processing apparatus 142 adjusts the irradiating time TL for irradiating with the light beam having the wavelength λ1 or λ2 and the exposure time Ts of the respective horizontal lines 0, 2, 4, 6, 8, 10, so that only the reflected light having one of the wavelengths λ1 and λ2 from among the plurality of horizontal lines which constitute the image pickup element of the camera 141 in the horizontal lines used for the skin detection is received.

### [Method of Adjusting Irradiating Time TL and Exposure Time Ts]

Referring now to FIG. 14, a method of adjusting the irradiating time TL and the exposure time Ts performed by the image processing apparatus 142 will be described.

The numerals 0, 2, 4, 6, 8, 10 shown on the left side in FIG. 14 indicate the six horizontal lines 0, 2, 4, 6, 8, 10 which are used for the skin detection among the twelve horizontal lines which constitute the image pickup element 141b integrated in the rolling-shutter-type camera 141. Other configurations are the same as those in FIG. 5, and hence the description is omitted.

Here, the total number L of the horizontal lines 0, 2, 4, 6, 8, 10 that receive reflected light having one of the wavelengths for at least a minimum exposure time (Ts×x/100) required for the skin detection is six, where x=100 and n=12, the expression (3) is expressed by the following expression (1′).

TL≧(6−1)×t/12+Ts×100/100 (1′)

When the expression (1′) is modified, the following expression (2′) is obtained.

TL≧5t/12+Ts (2′)

Then, as a combination (TL, Ts) of the irradiating time TL and the exposure time Ts which satisfies the expression (2′), for example, (TL, Ts)=(3t/4, t/3) can be employed as shown in FIG. 14.

In FIG. 14, the description is given on the assumption that the exposure time Ts is set to t/3, and the irradiating time TL is set to 3t/4. However, the exposure time Ts and the irradiating time TL are not limited thereto, and only have to satisfy the expression (2′) (or the expression (3)).

In the second embodiment, when the rolling-shutter-type camera 141 is used, the irradiating time TL for irradiating the light beam having one of the wavelengths λ1 and λ2 and the exposure time Ts so that only the reflected light having one of the wavelengths is received in the horizontal lines used actually for the imaging at the time of skin detection operation from among the horizontal lines which constitute the image pickup element 141b of the camera 141.

In other words, for example, as shown in FIG. 14, the irradiating time TL and the exposure time Ts are adjusted so that the reflected light having one of the wavelengths is received by the plurality of horizontal lines 0, 2, 4, 6, 8, for at least the exposure time (Ts×100/100) (although x=100 in this example, the invention is not limited thereto) required for the skin detection.

The image processing apparatus 142 controls the LEDs 61a to irradiate the object with the light beams having the wavelength λ1 for the irradiating time TL in the time t1.

Then, the image processing apparatus 142 controls the camera 141, and causes the horizontal lines 0, 2, 4, 6, 8, 10 of the image pickup element 141b to be irradiated with the reflected light reflected when the object is irradiated with the light beams having the wavelength λ1 for the exposure time Ts. Accordingly, the camera 141 creates the first skin detection image and supplies the same to the image processing apparatus 142.

Also, the image processing apparatus 142 controls the LEDs 61b to irradiate the object with the light beam having the wavelength λ2 for the irradiating time TL in the time t2.

Then, the image processing apparatus 142 controls the camera 141, and causes the plurality of the horizontal lines 0, 2, 4, 6, 8, 10 of the image pickup element 141b to be irradiated with the reflected light reflected when the object is irradiated with the light beams having the wavelength λ2 for the exposure time Ts. Accordingly, the camera 142 creates the second skin detection image and supplies the same to the image processing apparatus 142.

The image processing apparatus 142 detects the skin region on the first or the second skin detection images on the basis of the first and second skin detection images from the camera 142.

In the image pickup element 141b of the camera 141, the number of the horizontal lines to be used for the skin detection is not limited to six. In other words, for example, it is also possible to determine the number of horizontal lines within a range in which all the horizontal lines used for the skin detection can receive the reflected light having the wavelength λ1 from the object in the times t1, t3, . . . and the reflected light having the wavelength λ2 from the object in the times t2, t4, . . . , respectively in at least the minimum exposure time (Tx×x/100) required for the skin detection depending on the conditions. The arrangement of the horizontal line used for the skin detection is not limited to the arrangement shown in FIG. 12 or FIG. 13, and any arrangement is applicable.

### [Process to be Performed by Image Processing Apparatus 142]

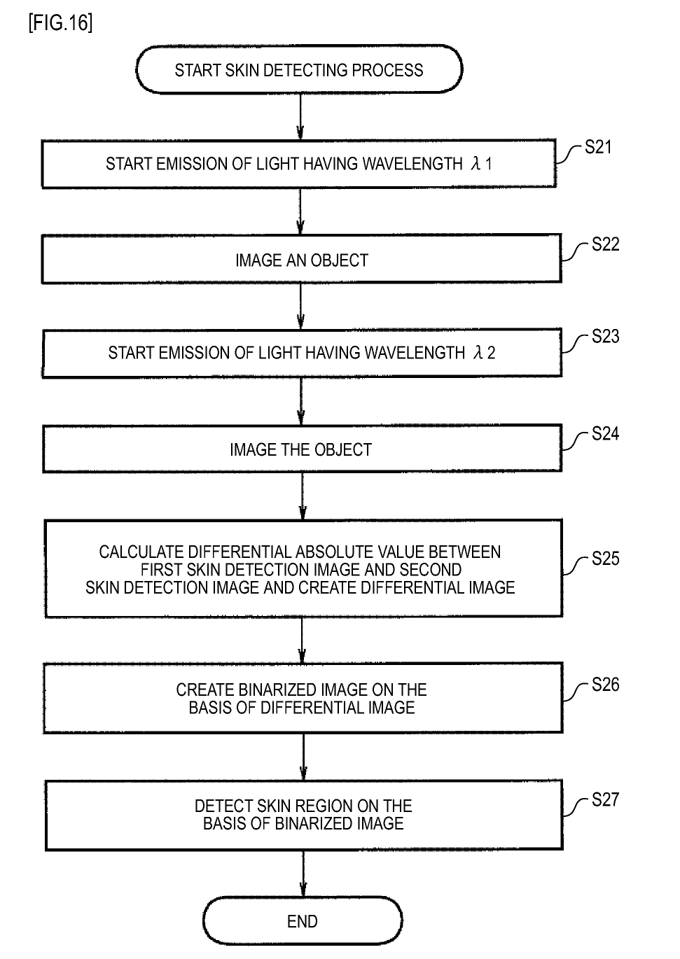

Subsequently, FIG. 15 shows an example of a configuration of the image processing apparatus 142.

For reference sake, parts of the image processing apparatus 142 configured in the same manner as the image processing apparatus 63 in FIG. 9 are designated by the same reference numerals, and hence the description thereof will be omitted as needed.

In other words, the image processing apparatus 142 is configured in the same manner as the image processing apparatus 63 in FIG. 9 except that a control unit 161 is provided instead of the control unit 101 in FIG. 9, and a calculating unit 162 is provided instead of the extracting unit 102 and the calculating unit 103 in FIG. 9.

The control unit 161 controls the light-emitting device 61 to cause the LEDs 61a and the LEDs 61b to emit (irradiate) light beams alternately. In other words, for example, the control unit 161 causes the LEDs 61a to irradiate the object with light beams having the wavelength λ1 for the irradiating time TL (the time from the start of exposure in the horizontal line 0 to the termination of the exposure in the horizontal line 10) in the times t1, t3, . . . .

For example, the control unit 161 causes the LEDs 61b to irradiate the object with light beams having the wavelength λ2 for the irradiating time TL in the times t2, t4, . . . .

The control unit 161 controls the camera 141 to image the object by causing the horizontal lines 0, 2, 4, 6, 8, 10 which constitute the image pickup element 141b integrated in the camera 141 to be exposed for the exposure time Ts from timings when the rising edges of the HD signal are detected in ascending order.

The first and second skin detection images are supplied from the camera 141 to the calculating unit 162. The calculating unit 162 smoothens the first and second skin detection images from the camera 141 using the LPF.

Then, the calculating unit 162 calculates differential absolute values between the luminance values of the first and second skin detection images after the smoothening, and supplies the differential image configured with pixels having the calculated differential absolute values as pixel values to the binary unit 104. The binary unit 104 binarizes the differential image from the calculating unit 162 in the same manner as in the first embodiment and, on the basis of a binarized image obtained thereby, detects the skin region and outputs the detected result.

### [Description on Operation of Information Processing System 121]

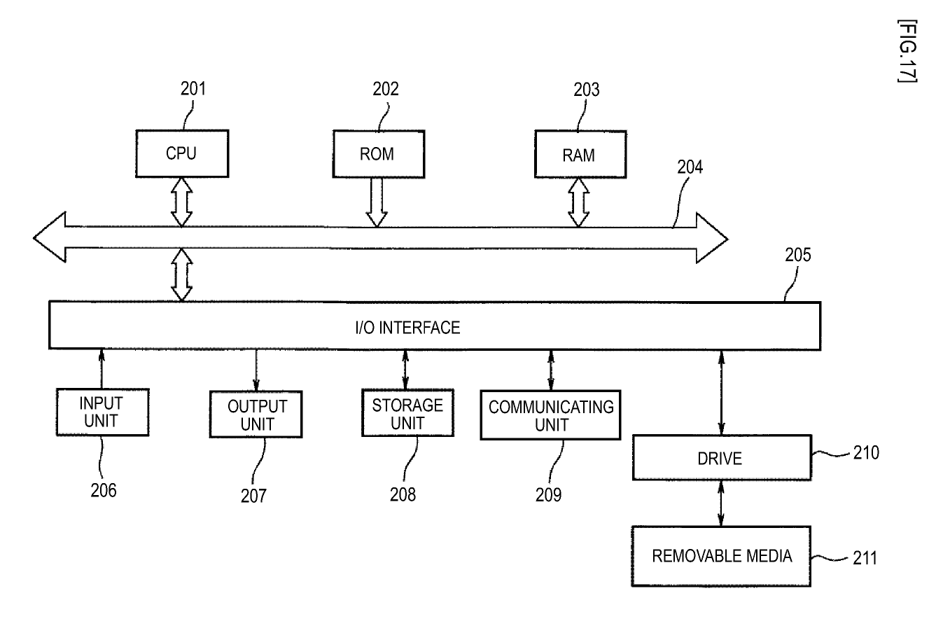

Subsequently, a skin detecting process performed by the information processing system 121 will be described with reference to a flowchart in FIG. 16.

This skin detecting process is performed repeatedly, for example, from when a power source of the information processing system 121 is turned on.

In step S21, the control unit 161 controls the LEDs 61a of the light-emitting device 61, and causes the LEDs 61a to irradiate the object with light beams having the wavelength λ1 for the irradiating time TL in the times t1, t3, . . . .

In Step S22, the camera 141 performs exposure for the exposure time Ts from the timings when the rising edges of the HD signal are detected for each of the horizontal lines 0, 2, 4, 6, 8, 10 of the image pickup element 141b integrated therein and supplies the first skin detection image obtained thereby to the calculating unit 162 of the image processing apparatus 142.

In Step S23, the control unit 161 controls the LEDs 61b of the light-emitting device 61, and causes the LEDs 61b to irradiate the object with light beams having the wavelength λ2 for the irradiating time TL in the times t2, t4, . . . . In this case, the LEDs 61a are assumed to be turned OFF.

In Step S24, the camera 141 performs exposure for the exposure time Ts from the timings when the rising edges of the HD signal are detected for each of the horizontal lines 0, 2, 4, 6, 8, 10 of the image pickup element 141b integrated therein, and supplies the second skin detection image obtained thereby to the calculating unit 162.

In Step S25, the calculating unit 162 smoothens the first and second skin detection images supplied from the camera 141 using the LPF. Then, the calculating unit 162 creates a differential image on the basis of the differential absolute values between the luminance values of the corresponding pixels of the first and second skin detection images after the smoothening, and supplies the same to the binary unit 104.

In Step S26, the binary unit 104 binarizes the differential image supplied from the calculating unit 162. Then, in Step S27, the binary unit 104 detects the skin region from the binary image obtained by binarization. The skin detecting process in FIG. 16 is now terminated.

As described above, according to the skin detecting process in FIG. 16, only the six horizontal lines selected alternately from among the twelve horizontal lines which constitute the image pickup element of the camera 141 are configured to be used. However, the horizontal lines may be selected every two lines or three lines instead of being selected alternately. Also, recently, depending on the type of the camera, there is a type which allows selection of image quality modes at the time of imaging. For example, when there are choices of VGA and QVGA, the number of horizontal lines of the image pickup element used at the time of imaging for the QVGA will be half that of the VGA.

Therefore, in the second embodiment, when the specification of the image quality mode selection of the camera as described above satisfies the conditions and can be used in the image processing apparatus 142, the skin region can be detected directly on the basis of the first and second skin detection images from the camera 141 without performing the process of extracting the first and second extracted images from the first and second picked-up images as in the first embodiment.

In such a case, a DSP (Digital Signal Processor) which is operated as the image processing apparatus 142 can be obtained at cost lower than the DSP which is operated as the image processing apparatus 63 in the first embodiment. Accordingly, for example, production of the information processing system 121 which is lower in production cost than the information processing system 41 is achieved.

According to the skin detecting process in FIG. 16, since the region created by the horizontal lines 0, 2, 4, 6, 8, 10 from among the horizontal lines 0 to 11 are used as the first and second skin detection images, in the same manner as the case where the regions generated almost by the horizontal lines 0 to 11 are used as the first and second skin detection images, the detection of the skin region with a large angle of field is enabled. Therefore, a gesture operation by a user can be figured out in a wider range.

### 3. Modifications

In the first embodiment, for example, the first picked-up image is configured to be obtained by irradiating with the light beams having the wavelength λ1 from the LEDs 61a for the irradiating time TL in the time t2, and the light beam having the wavelength λ2 are irradiated from the LEDs 61b for the irradiating time TL in the time t3, so that the second picked-up image different from the first picked-up image by one frame. However, the invention is not limited thereto.

In other words, for example, where L=12, n=12, and x=100, from the expression (3), TL≧11t/12+Ts is established and, for example, (TL, Ts)=(7t/6, t/4) are employed. However, in this case, the irradiating time TL becomes a period from the start of exposure of the horizontal line 0 until the termination of the exposure of the horizontal line 11.

Therefore, when the camera 62 is configured to image the first and second picked-up images different by one frame as the first and second picked-up images, the region extracted as the first extracted image (the total region which constitutes the first picked-up image) is unintentionally the one obtained by receiving the reflected lights having the wavelength λ1 and the wavelength λ2. Much the same is true on the region extracted as the second extracted image.

Therefore, in such a case, the control unit 101 of the image processing apparatus 63 controls the LEDs 61a and the LEDs 61b so that the irradiating period of the light beams having the wavelength λ1 by the LEDs 61a does not overlap with the irradiating period of the light beams having the wavelength λ2 by the LEDs 61b. Then, the first and second picked-up images different by a predetermined number of frames are imaged in the camera 62.

More specifically, for example, a relation (TL, Ts)=(7t/6, t/4) is employed, the first and second picked-up images are created in a manner described below so that the irradiating period of the light beams having the wavelength λ1 by the LEDs 61a does not overlap with the irradiating period of the light beams having the wavelength λ2 by the LEDs 61b.

For example, in FIG. 5, the light beam having the wavelength λ1 is irradiated from a moment when the tenth rising edge of the HD signal generated in the time t1 appears until a moment when the twelfth rising edge appears in the time t2. In this case, the first picked-up image is obtained by the camera 62, and the obtained image is supplied to the image processing apparatus 63.

Subsequently, in FIG. 5, irradiation of the light beam having the wavelength λ1 and the light beam having the wavelength λ2 is stopped from the moment when the twelfth rising edge of the HD signal generated in the time t2 appears until a moment when the tenth rising edge appears in the time t3. In this case, the picked-up image obtained by imaging of the camera 62 is not used for the skin detection, and hence is ignored (or discarded) in the image processing apparatus 63.

Then, for example in FIG. 5, the light beam having the wavelength λ2 is irradiated from the moment when the tenth rising edge of the HD signal generated in the time t3 appears until a moment when the twelfth rising edge appears in the time t4. In this case, the second picked-up image is obtained by the camera 62, and the obtained image is supplied to the image processing apparatus 63.

The image processing apparatus 63 is configured to detect the skin region on the basis of the first picked-up image from the camera 62 and the second picked-up image imaged after two frames from the first picked-up image.

Here, as shown in FIG. 5, for example, the camera 62 is configured to start imaging at a predetermined image pickup timings (the intervals of the time t). In order to detect the skin region more accurately, it is preferable to detect the skin region on the basis of the first picked-up image obtained at a predetermined image pickup timing and the second picked-up image obtained at an imaging timing elapsed by the time t from the predetermined image pickup timing considering that the object moves or the like.

In other words, the image processing apparatus 63 preferably detects the skin region on the basis of the first picked-up image and the second picked-up image imaged after one frame from the first picked-up image.

Therefore, in the first embodiment, the irradiating time TL preferably does not exceed the time t from the rising edge appeared in the VD signal to the next appearance of the rising edge (the same time as the times t1, t2, t3, t4).

When the irradiating time TL is set to the time t or shorter, overlapping of the light irradiation period of light beams having the wavelength λ1 by the LEDs 61a and the light irradiation period of light beams having the wavelength λ2 by the LED 61b may be avoided and, simultaneously, the skin region may be detected on the basis of the first picked-up image and a second picked-up image imaged after one frame from the first picked-up image. In other words, in the camera 62, improvement of the frame rate for creating the first and second picked-up images is achieved. This is the same also in the second embodiment.

In addition, in the first embodiment, the irradiating time for irradiating the light beam having the wavelength λ1 from the LEDs 61a and the irradiating time for irradiating the light beam having the wavelength λ1 from the LED 61b are set to be the irradiating time Ts (=t/4), which is the same length. However, the irradiating time for irradiating the light beam having the wavelength λ1 from the LED 61a and the irradiating time for irradiating the light beam having the wavelength λ1 from the LED 61b may be the different length from each other. This is the same also in the second embodiment.

Also, in the first embodiment, the light beam having one of the wavelengths is continuously irradiated for the irradiating time TL so that the reflected light having one of the wavelengths can be received for at least the minimum exposure time (Ts×x/100) required for the skin detection in the respective horizontal lines 6 to 11. However, any irradiating method may be used as long as the reflected light having one of the wavelengths can be received for at least the minimum exposure time (Ts×x/100) required for the skin detection in the respective horizontal lines 6 to 11. More specifically, for example, in the irradiating time TL, the light beam having one of the wavelengths may be irradiated intermittently. This is the same also in the second embodiment.

In addition, in the first embodiment, as shown in FIG. 5, in the horizontal lines 6 to 11 which constitute the image pickup element of the camera 62, the exposure time when receiving the reflected light having the wavelength λ1 from the object and the exposure time when receiving the reflected light having the wavelength λ2 from the object are set to be the same. However the invention is not limited thereto.

In other words, for example, if the exposure time when receiving the reflected light having the wavelength λ1 from the object is enough for receiving the reflected light having the minimum wavelength λ1 required for the skin detection and also the exposure time when receiving the reflected light having the wavelength λ2 from the object is enough for receiving the reflected light having the minimum wavelength λ2 required for the skin detection, the exposure times may be different from each other. This is the same also in the second embodiment.

Although the combination of the wavelength λ1 and the wavelength λ2 is defined to be the combination of 870 [nm] and 950 [nm] in the first embodiment, the combination of the wavelengths may be any combination as long as the differential absolute value between the reflectance with the wavelength λ1 and the reflectance with the wavelength λ2 is large enough in comparison with the differential absolute value of the reflectance obtained from substances other than the user's skin.

More strictly, the combination may be any combination as long as the differential obtained by subtracting the reflectance with the wavelength λ2 from the reflectance with the wavelength λ1 is sufficiently large enough in comparison with the differential of the reflectance obtained from the substances other than the user's skin.

More specifically, as is apparent from FIG. 7, a configuration in which the LEDs 61a emit the irradiating light beams having the wavelength λ1, which is smaller than 930 [nm], and the LEDs 61b emit the irradiating light beams having the wavelength λ2, which is equal to or larger than 930 [nm], for example, a combination of 800 [nm] and 950 [nm], a combination of 870 [nm] and 1000 [nm] in addition to the combination of the 870 [nm] and 950 [nm], and a combination of 800 [nm] and 1000 [nm] is applicable.

In other words, for example, the skin detection can be performed with high degree of accuracy by selecting the value of the wavelength λ1 from a range from 640 nm to 1000 nm, and the value of the wavelength λ2 from a range from 900 nm to 1100 nm as a combination of the wavelength λ1 and the wavelength λ2 longer than the wavelength λ1.

However, the ranges of the wavelengths λ1 and λ2 are preferably a near-infrared range except for the visible light range in order to avoid the object as an operator of the information processing system 41 or the information processing system 121 from feeling glare by the irradiation of the LEDs 61a and the LEDs 61b.

When using the visible light as the light beams to be irradiated from the LEDs 61a, a filter which allows only the visible light emitted from the LEDs 61a to pass therethrough and enter a lens of the camera 62 is used instead of the visible light cut filter 62a. Much the same is true on the LEDs 61b.

In the first embodiment, the information processing system 41 has been described. However, the information processing system 41 may be configured to be integrated in an electronic apparatus such as a television receiving set, which is configured to change the channel (frequency) to be received according to the result of detection of the skin region detected by the information processing system 41. Also, for example, the information processing system 41 may be integrated in the electronic apparatus which is portable by being brought with such as a mobile phone in addition to the television receiving set. This is the same also in the second embodiment.

Incidentally, a series of processes described above may be executed by specific hardware and may be executed by software. When causing the software to execute the series of processes, a program which constitutes the software is installed from a recording media to so-called an integrated computer, or, for example, a general-purpose personal computer which is capable of executing various types of functions by installing various types of programs.

### [Example of Configuration of Computer]

Subsequently, FIG. 17 shows an example of a configuration of a personal computer which executes the series of processes described above by a program.

A CPU (Central Processing Unit) 201 executes various processes by a program stored in an ROM (Read Only Memory) 202 or a storage unit 208. A program to be executed by the CPU 201 or data are stored as needed in an RAM (Random Access Memory) 203. The CPU 201, the ROM 202, and the RAM 203 are connected with each other by a bus 204.

An I/O interface 205 is also connected to the CPU 201 via the bus 204. An input unit 206 including a keyboard, a mouse, and a microphone, and an output unit 207 including a display and a speaker are connected to the I/O interface 205. The CPU 201 executes various processes corresponding to commands input from the input unit 206. The CPU 201 outputs the result of process to the output unit 207.

The storage unit 208 connected to the I/O interface 205 is, for example, a hard disk, and stores a program or various data to be executed by the CPU 201. A communicating unit 209 communicates with the external devices via a network such as the internet or the local region network.

Also, the program may be acquired via the communicating unit 209 and stored in the storage unit 208.

When a removable media 211 such as a magnet disk, an optical disk, a magneto-optical disk, or a semi-conductor memory is mounted, a drive 210 connected to the I/O interface 205 drives these members and acquires a program, data, and the like recorded therein. The acquired program and the data are transferred to the storage unit 208 as needed, and are stored therein.

Recording media recording (storing) a program to be installed in the computer and to be brought into a state of being executable by the computer includes, as shown in FIG. 17, magnetic disks (including flexible disks), optical disks (including a CD-ROM (Compact Disc-Read Only Memory), and a DVD (Digital Versatile Disc)), magneto-optical disks (including MD (Mini-Disc)), or the removable disk media 211 which is a package media including a semi-conductor memory or the ROM 202 in which the program is temporarily or permanently stored, or a hard disk which constitutes the storage unit 208. Recording of the program into the recording medium is performed by using wired or wireless communication media such as the local region network, the internet, or the digital satellite broadcasting via the communicating unit 209, which is an interface such as a router or a modem as needed.

In this specification, the step of describing the series of processes described above includes not only a process to be performed in time series along the described order as a matter of course, but also a process to be executed in parallel or individually even though it is not processed in time series.

In this specification, the system represents the entire apparatus including a plurality of apparatuses.

The embodiments of the present invention are not limited to the first and second embodiments described above, and various modifications may be made without departing the scope of the present invention.

### REFERENCE NUMERALS

41 information processing system,
61 light-emitting device, 61a, 61b LED,
62 visible light cut filter, 62 camera,
63 image processing apparatus, 101 control unit,
102 extracting unit, 103 calculating unit,
104 binary unit, 121 information processing system,
141 camera,
142 image processing apparatus, 161 control unit,
162 calculating unit

1. An information processing apparatus configured to detect a skin region which indicates human skin from a picked-up image obtained by imaging an object comprising:
first irradiating means configured to irradiate the object with light having a first wavelength;
second irradiating means configured to irradiate the object with light having a second wavelength which is longer than the first wavelength;
creating means including an image pickup element having a plurality of lines including skin detection lines used for receiving reflected light from the object and creating a skin detection region used for detecting the skin region integrated therein and configured to receive the reflected light from the object at different timings for each of the plurality of lines and create the picked-up image including at least the skin detection region;
control means configured to control the first irradiating means, the second irradiating means, and the creating means and to cause the skin detection lines to be irradiated with the reflected light from the object and create the first picked-up image including at least the skin detection region in a state in which the object is irradiated with the light having the first wavelength, and configured to cause the skin detection lines to be irradiated with the reflected light from the object and create the second picked-up image including at least the skin detection region in a state in which the object is irradiated with the light having the second wavelength, and
detecting means configured to detect the skin region on the basis of the first picked-up image and the second picked-up image.

2. The information processing apparatus according to claim 1, wherein the image pickup element includes the plurality of lines including the skin detection lines arranged at intervals of n (n is natural numbers) lines,
the control means controls the first irradiating means, the second irradiating means, and the creating means to cause the skin detection lines to be irradiated with the reflected light from the object and create the first picked-up image including the skin detection region as a first skin detection image in a state in which the object is irradiated with the light having the first wavelength, and cause the skin detection lines to be irradiated with the reflected light from the object and create the first picked-up image including the skin detection region as a second skin detection image in a state in which the object is irradiated with the light having the second wavelength, and
the detecting means detects the skin region on the basis of the first skin detection image and the second skin detection image.

3. The information processing apparatus according to claim 1, wherein the control means controls the first irradiating means, the second irradiating means, and the creating means to cause the skin detection lines to be irradiated with the reflected light from the object and create the first picked-up image including the skin detection region in a state in which the object is irradiated with the light having the first wavelength, and
cause the skin detection lines to be irradiated with the reflected light from the object and create the second picked-up image including the skin detection region in a state in which the object is irradiated with the light having the second wavelength, and
the detection means includes extracting means configured to extract the skin detection region included in the first picked-up image as the first extracted image and extract the skin detection region included in the second picked-up image as the second extracted image and
skin region detecting means configured to detect the skin region o the basis of the first and second extracted images.

4. The information processing apparatus according to claim 1, wherein the control means controls the first irradiating means, the second irradiating means, and the creating means to cause the skin detection lines to be irradiated with the reflected light from the object for at least a predetermined light-receiving time in a state in which the object is irradiated with the light having the first wavelength, and
cause the skin detection lines to be irradiated with the reflected light from the object for at least the predetermined light-receiving time in a state in which the object is irradiated with the light having the second wavelength.

5. The information processing apparatus according to claim 1, wherein the creating means images the object in sequence at predetermined image pickup timings to create the picked-up image; and
the control means controls the first irradiating means, the second irradiating means, and the creating means to create the first picked-up image at a predetermined image pickup timing and create the second picked-up image at a next image pickup timing of the predetermined image pickup timing.

6. The information processing apparatus according to claim 1, wherein the first and second irradiating means emit light having a wavelength of a case where the differential obtained by subtracting the reflectance of the reflected light obtained by irradiating the human skin with the light having the second wavelength from the reflectance of the reflected light obtained by irradiating the same with the light having the first wavelength becomes a predetermined differential threshold value or larger.

7. The information processing apparatus according to claim 6, wherein a first wavelength λ1 and a second wavelength λ2 satisfy
640nm≦λ1≦1000nm
900nm≦λ2≦1100nm.

8. The information processing apparatus according to claim 7, wherein the first irradiating means irradiates the object with a first infrared ray as the light having the first wavelength, and
the second irradiating means irradiates the object with a second infrared ray having a longer wavelength than the first infrared ray as the light having the second wavelength.

9. The information processing apparatus according to claim 1 or 2, wherein the detecting means detects the skin region on the basis of the luminance value of the first picked-up image and the luminance value of the second picked-up image.

10. The information processing apparatus according to claim 3, wherein the skin region detecting means detects the skin region on the basis of the luminance value of the first extracted image and the luminance value of the second extracted image.

11. An information processing method of an information processing apparatus configured to detect a skin region which indicates human skin from a picked-up image obtained by imaging an object, wherein the information processing apparatus comprises:
first irradiating means;
second irradiating means;
creating means;
control means; and
detecting means, comprising the steps that
the first irradiating means irradiates the object with light having a first wavelength;
the second irradiating means irradiates the objet with light having a second wavelength which is longer than the first wavelength;
the creating means includes an image pickup element having a plurality of lines including skin detection lines used for receiving reflected light from the object and creating a skin detection region used for detecting the skin region integrated therein and receives the reflected light from the object at different timings for each of the plurality of lines and creates the picked-up image including at least the skin detection region;
the control means controls the first irradiating means, the second irradiating means, and the creating means and causes the skin detection lines to be irradiated with the reflected light from the object and creates the first picked-up image including at least the skin detection region in a state in which the object is irradiated with the light having the first wavelength, and causes the skin detection lines to be irradiated with the reflected light from the object and creates the second picked-up image including at least the skin detection region in a state in which the object is irradiated with the light having the second wavelength, and
the detecting means detects the skin region on the basis of the first picked-up image and the second picked-up image.

12. A program configured to cause a computer of an information processing apparatus configured to detect a skin region which indicates human skin from a picked-up image obtained by imaging an object to function as
control means configured to control first irradiating means, second irradiating means, and creating means and to cause skin detection lines to be irradiated with reflected light from the object and create a first picked-up image including at least a skin detection region in a state in which the object is irradiated with light having a first wavelength, and configured to cause the skin detection lines to be irradiated with the reflected light from the object and create a second picked-up image including at least the skin detection region in a state in which the object is irradiated with light having a second wavelength, and
detecting means configured to detect the skin region on the basis of the first picked-up image and the second picked-up image,
the information processing apparatus including
the first irradiating means configured to irradiate the object with the light having the first wavelength; the second irradiating means configured to irradiate the object with the light having the second wavelength which is longer than the first wavelength; and the creating means including an image pickup element having a plurality of lines including skin detection lines used for receiving the reflected light from the object and creating the skin detection region used for detecting the skin region integrated therein and configured to receive the reflected light from the object at different timings for each of the plurality of lines and create the picked-up image including at least the skin detection region.

13. An electronic apparatus including an information processing apparatus configured to detect a skin region which indicates human skin from a picked-up image obtained by imaging an object integrated therein, wherein
the information processing apparatus includes:
first irradiating means configured to irradiate the object with light having a first wavelength;
second irradiating means configured to irradiate the object with light having a second wavelength which is longer than the first wavelength;
creating means including an image pickup element having a plurality of lines including skin detection lines used for receiving reflected light from the object and creating a skin detection region used for detecting the skin region integrated therein and configured to receive the reflected light from the object at different timings for each of the plurality of lines and create the picked-up image including at least the skin detection region;
control means configured to control the first irradiating means, the second irradiating means, and the creating means and to cause the skin detection lines to be irradiated with the reflected light from the object and create the first picked-up image including at least the skin detection region in a state in which the object is irradiated with the light having the first wavelength, and configured to cause the skin detection lines to be irradiated with the reflected light from the object and create the second picked-up image including at least the skin detection region in a state in which the object is irradiated with the light having the second wavelength, and
detecting means configured to detect the skin region on the basis of the first picked-up image and the second picked-up image.
